(19) United States
(12) Patent Application Publication
(10) Pub. No.: US 2026/0304290 A1
(43) Pub. Date: Oct. 1, 2026

(54) HANDLING OF NON-NETWORK ENERGY SAVINGS CAPABLE UE MOBILITY IN NETWORK ENERGY SAVINGS CAPABLE CELLS

(71) Applicant: Telefonaktiebolaget LM Ericsson (publ), Stockholm (SE)

(72) Inventors: Ali NADER, Malmö (SE); Nianshan SHI, Järfälla (SE); Sladana JOSILO, Solna (SE); Sina MALEKI, Malmö (SE); Andres REIAL, Hollviken (SE); Lian ARAUJO, Solna (SE)

(21) Appl. No.: 18/881,360

(22) PCT Filed: Sep. 25, 2023
(86) PCT No.: PCT/EP2023/076373

§ 371 Date: Jan. 6, 2025

Related U.S. Application Data
(60) Provisional application No. 63/411,534, filed on Sep. 29, 2022.
(60) Provisional application No. 63/414,636, filed on Oct. 10, 2022.

(51) Int. Cl. H04W 48/02; H04W 48/12

(52) U.S. Cl. CPC H04W 48/02; H04W 48/12

(57) ABSTRACT

A method implemented in a UE includes receiving a first signal or a first sequence from a cell, and determining from a bit, a flag, or a signature in the first signal or the first sequence whether the UE is indicated as being barred from accessing the cell. Responsive to when a result of the determination is that the UE is not indicated as being barred from accessing the cell, the method determines from a second signal or a second sequence received from the cell whether the UE is further indicated as being barred from accessing the cell. The second signal or the second sequence includes information indicating whether the cell is barred or not barred for all NES capable UEs. Other related methods implemented by network nodes, NES-capable network nodes, and non-NES-capable network nodes are disclosed.

### TECHNICAL FIELD

The present disclosure relates generally to communications, and more particularly to communication methods and related devices and nodes supporting wireless communications.

### BACKGROUND

Network (NW) energy consumption in New Radio (NR) increases with respect to LTE due to more complex hardware (HW), e.g., higher bandwidth (BW) and a greater number of antennas. This is particularly more evident when the NW operates in higher frequencies. Hence it is important for the NW to turn ON/OFF unused HW modules during inactivity times. For example, in frequency range 2 (FR2), an NR gNB can be configured with up to 64 beams and transmit up to 64 synchronization signal blocks (SSBs). This implies 64 ports with many transceiver chains involved. Such SSBs are transmitted every 20 ms in during 5 ms windows for the sake of providing coverage to potential user equipments (UEs) even if there actually are no UEs present in the cell. Another example of energy costly always-on broadcast transmissions is system information block 1 (SIB1) which is typically transmitted (per beam) every 20/40 ms.

An option for saving NW energy is to simply turn off a gNB or cell completely when it is seen or predicted that there is no traffic or even no user in the cell. However, during ongoing 3GPP Rel-18 work, more elaborate schemes are being discussed in which the gNB may be operational but in a reduced energy state. Example of such reduced energy state schemes are gNBs operating in discontinuous transmit/receive (DTRX), reduced set of broadcast signals such as system information, etc. The term Network Energy Saving (NES) is used in this description as a common term for various schemes.

A UEs position in RRC_IDLE state is known to the NW (Core NW (CN)) on a Registration Area level including one or more Tracking Areas which in turn can include one or more cells (typically multiple cells). UE in RRC_IDLE performs a Registration Area Update procedure with CN when it enters a new registration area.

Similarly, a UE's position in RRC_INACTIVE state is known to the NW (gNB) on a RAN Notification Area (RNA) level including one or more cells. UE in RRC_INACTIVE performs an RNA Area Update procedure with the gNB when it enters a cell belonging to a new RNA.

The Tracking Area Code(s), the RAN Area Code, and the Cell Identity that are used by the UE in the said states for determining whether a registration update procedure is needed are broadcast in SIB1 of the cells.

There currently exist certain challenge(s). The reduced energy schemes used by NES-capable gNBs require that the UEs are also capable of such schemes to be able to operate in the NES-capable cells. However, there will for quite some time ahead exist many legacy UEs that cannot function in the NES-capable cells. Hence, either the deployment of these cells can only be in small areas where it is guaranteed that only new NES-capable UEs will exist (e.g., in a factory or other controlled environments), or the operator needs to make sure that NES-capable cells are overlapped with cells that can handle legacy traffic.

### SUMMARY

Some embodiments disclosed herein are directed to a method implemented in a UE. The method includes receiving a first signal or a first sequence from a cell, and determining from a bit, a flag, or a signature in the first signal or the first sequence whether the UE is indicated as being barred from accessing the cell. Responsive to when a result of the determination is that the UE is not indicated as being barred from accessing the cell, the method determines from a second signal or a second sequence received from the cell whether the UE is further indicated as being barred from accessing the cell. The second signal or the second sequence comprises information indicating whether the cell is barred or not barred for all NES capable UEs.

Some other embodiments are directed to a method implemented in a network node. The method includes generating a first signal or a first sequence containing a bit, a flag, or a signature indicating whether UEs are barred from accessing a cell. The method initiates transmission of the first signal or the first sequence in the cell. Responsive to when the indication of the first signal or the first sequence is that UEs are barred from accessing the cell, the method generates a second signal or a second sequence further indicating whether UEs are barred from accessing the cell, and initiates transmission of the second signal or the second sequence in the cell. The second signal or the second sequence comprises information indicating whether the cell is barred or not barred for all NES capable UEs.

Some other embodiments are directed to a method implemented in a first NES-capable network node. The method includes receiving information indicating presence of a non-NES capable UE or presence of a UE operating incompatibly with a NES mode of the NES-capable network node, and dynamically switching from the NES mode to a non-NES mode based on the received information.

Some other embodiments are directed to a method implemented in a first network node serving a non-NES-capable cell that at least partially overlaps a NES capable cell served by a second network node. The method includes initiating broadcast of a configuration blacklist identifying the NES-capable cell or a configuration whitelist that does not identify the NES-capable cell.

Advantages that may be provided by one or more of these embodiments include that they allow for deployment of NES-capable cells with no or limited impact on legacy UEs. Furthermore, these embodiments may allow for deployment of NES-capable cells even though there is not a coverage cell overlapping with the NES-capable cell. Barring access in accordance with one or more of these embodiments can avoid having legacy UEs or non-NES capable UEs increase the load on NES capable cells and avoid wasting energy related to hopelessly trying to access such NES capable cells.

Other methods implemented by UEs and network nodes and corresponding UEs and networks will be or become apparent to one with skill in the art upon review of the following drawings and detailed description. It is intended that all such additional methods and corresponding UEs and network nodes be included within this description, be within the scope of the present inventive subject matter, and be protected by the accompanying claims. Moreover, it is intended that all embodiments disclosed herein can be implemented individually or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates operations and communications of a legacy UE, serving NG-RAN, and CN through which the CN detects the legacy UE, and the NG-RAN node restores to normal state, according to some embodiments of inventive concepts;

FIG. 2 illustrates operations and communications of a gNB-CU and gNB-DU in the split NG-RAN architecture, according to some embodiments of inventive concepts;

FIG. 3 illustrates operations and communications of a first NG-RAN node and a second NG-RAN node as the first NG-RAN node prepares the second NG-RAN node as a handover target, according to some embodiments of inventive concepts;

FIG. 4 illustrates a flow chart illustrating operations of a first network energy saving (NES)-capable network node according to some embodiments of inventive concepts;

FIG. 5 illustrates a flow chart illustrating operations of a first network node serving a non-network energy saving, NES,-capable cell that at least partially overlaps a NES capable cell served by a second network node according to some embodiments of inventive concepts;

FIG. 6 is a flowchart of operations that can be implemented by a UE in accordance with some embodiments of the present disclosure;

FIG. 7 is a flowchart of operations that can be implemented by a network node in accordance with some embodiments of the present disclosure;

FIG. 8 illustrates a block diagram of a communication system in accordance with some embodiments;

FIG. 9 illustrates a block diagram of a user equipment in accordance with some embodiments

FIG. 10 illustrates a block diagram of a network node in accordance with some embodiments;

FIG. 11 illustrates a block diagram of a host, which may be an embodiment of a host in accordance with some embodiments;

FIG. 12 illustrates a block diagram of a virtualization environment in accordance with some embodiments; and

FIG. 13 illustrates a communication diagram of a host communicating via a network node with a user equipment over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Potential problems with trying to deploy NES-capable cells in small areas where only new NES-capable UEs may exist or deploying NES-capable cells overlapped with cells that can handle legacy traffic, can include that a legacy UE may try (and keep retrying) to roam into a NES-capable cell when it detects such cell. This may cause temporary outage until the UE reselects (back) to a legacy cell. Currently, there is no clear mechanism(s) to hinder a legacy UE from roaming (reselecting) into a NES capable cell.

Furthermore, it may not always be desirable/possible for the operator to have an overlapping cell and therefore solutions are necessary to avoid service interruptions for legacy UEs.

The proposed solutions could allow for deployment of NES-capable cells with no or limited impact on legacy UEs. Furthermore, it could allow for deployment of NES-capable cells even though there is not a coverage cell overlapping with the NES-capable cell.

The present disclosure describes three sets of embodiments.

A first set of embodiments is directed to enabling a NES-capable gNB or a connected node (e.g., Core NW (CN) node) to detect the presence of a legacy UE in a NES-capable cell and dynamically change the gNB's role in a NW with respect to NES or legacy functionality. The role/state can be changed by the node itself, or another node (e.g., CN) can request (or give permission for) the role/state change. In some embodiments, the detection of Idle/inactive mode UEs in the NW can be done by tailoring the registration areas.

A second set of embodiments is directed to preventing legacy UEs from attempting to roam into NES capable cells.

A third set of embodiments, which may be based upon the first set of embodiments, is directed to allowing legacy UEs to roam into and/or connect to NES capable cells, where the NES-capable cell continues NES operation, regarding at least a subset of NES features, and adopts a special handling of legacy UEs so that NES features remain invisible to these legacy UEs or the gNB is more tolerant to inaccuracies resulting from UE operation that is unaware of NES features.

### Second Set of Embodiments

The second set of embodiments are directed to not allowing a non-NES-capable UE (e.g., legacy UE) to roam into a NES-capable cell. For example, the NES-capable cell is covered/overlapped by a so-called coverage cell with sufficient capacity and can serve legacy UEs. As such, the non-NES-capable UEs will not suffer from coverage holes when roaming around in the area. However, depending on non-NES-capable UEs' measurements of the NES-capable cells, the NES-capable cell may become an attractive candidate for cell reselection during RRC_Idle/Inactive or be reported to the NW as a candidate for handover (HO). In connected mode the hosting gNB could ignore such measurement report. However, it may be preferred to avoid such unnecessary signaling/reporting to the NW, both in terms of NW overhead as well as UE energy efficiency (i.e., the UE does not need to unnecessary measure this node). Therefore, in connected mode the NW, based on UE capability, is able to have the UE avoid measurement and reporting on NES-capable cells by making sure that the NES-capable cells are part of a measurement blacklist, or alternately not part of the whitelist.

In RRC_Idle/Inactive, the NW may interact with the UEs' mobility schemes through broadcast configuration. The objective being to avoid the non-NES-capable UE from, every now and then, trying to reselect to NES-capable cell of good quality causing potential interruptions and UE battery wastage. Therefore, it is described herein that the gNB helps ensure that neighboring NES-capable cells and/or frequencies are blacklisted (or not whitelisted). However, since the intention is that the NES-capable UEs are allowed to roam into the NES-capable cells, a new set of white/black-listing parameters are introduced specifically for NES-capable UEs. As such, the NES-capable UEs obey these white/black-listing parameters instead if broadcast instead of the legacy parameters. Therefore, a NES-capable UE receives a list of parameters from a higher layer signal, (e.g., a broadcast message indicating the cells that it can measure and not) which includes a NES node as a cell that it can measure. If the measurements indicate that the NES-capable UE can access the cell or that it is better to camp on a NES capable node, then the NES-capable UE may access that cell. On the other hand, a non-NES capable UE receives the same message, and since the NES capable node is blacklisted, then the non-NES capable UE does not measure that node and does not try to access the node.

In some embodiments, the NES capable node informs the non-NES capable nodes that it does not want non-NES capable UEs to camp on the NES capable node, through the node interfaces. In another embodiment, the CN decides whether the non-NES capable nodes should have non-NES capable UEs camp on the NES capable node, and informs the nodes as such.

In other embodiments, the NES capable node turns off NES features or keeps only the features which can be used by a non-NES capable UE, and thereby informs the neighbor nodes that now the NES capable node can be whitelisted.

### First Set of Embodiments

The first set of embodiments is directed to allowing a non-NES-capable UE to roam into a NES-capable cell. Perhaps there is no overlapping coverage cell and there is a risk for the UE to end up in a coverage hole. Therefore, the objective is to temporarily make sure that the NES-capable cell operates in a non-NES-manner or partially non-NES manner towards this non-NES-capable UE while the UE is in the coverage of the cell.

As the mobility of the UE is NW-controlled in RRC_CONNECTED mode, a radio access network (RAN) node hosting the non-NES-capable UE informs the NES-capable neighbor that a handover request is for a non-NES-capable UE. If the NES-capable neighbor node accepts the handover, and if the NES-capable neighbor is currently operating in a NES mode, it dynamically changes its operation mode to non-NES mode while serving the UE.

It should be noted that non-NES mode does not necessarily mean that the node has no energy saving scheme at all. It just means in this context that it will not maintain an energy saving scheme that would not allow a legacy (non-NES-capable) UE to operate. For example, the NES-capable cell may stop using gNB DTRX mode while the UE is in its cell but still operate in NES-manner towards other NES-capable UEs in dedicated communication (e.g., an adapted number of antennas which can be transparent to or handled by a non-NES capable UE, or a transmit power which is transparent to or can be handled by a non-NES capable UE).

In RRC_IDLE/INACTIVE, the mobility is UE-controlled based on UE's measurements. Furthermore, the existence of the UE is generally not known on cell-level. The UE generally performs registration update procedure when it crosses its registration area boundary. Therefore, a way to help ensure that the UE announces its presence in the NES-capable cell is that the cell belongs to a different registration area compared to neighboring cells handling non-NES-capable UEs. If the UE is in RRC_IDLE state it may perform a registration update procedure towards the CN. If the UE is in RRC_INACTIVE it may perform its registration procedure towards the gNB.

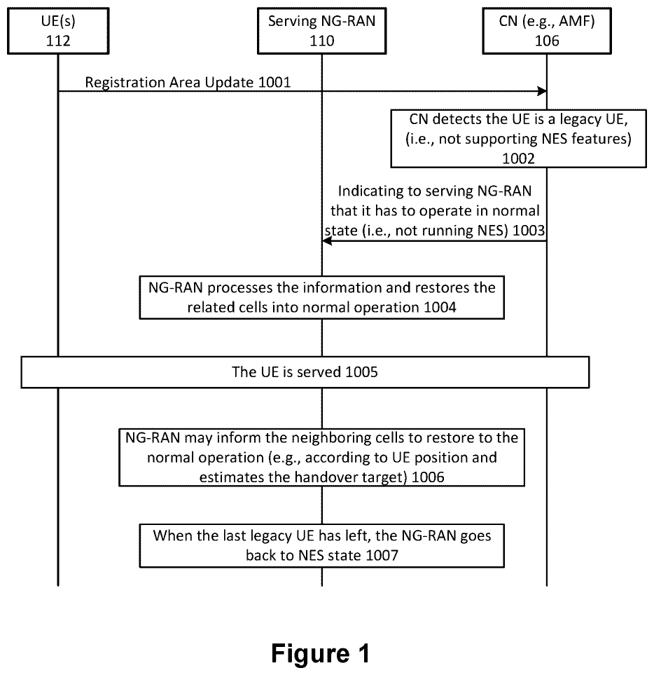

Once the UE's presence is detected and based on the UE capability it is known that the UE is non-NES-capable. If the NES-capable gNB wants to serve the UE, the NES-capable gNB goes into non-NES mode while the UE is in the NES-capable gNB's coverage. The gNB can do this change on its own or be triggered by external signaling. For example, in RRC_INACTIVE the gNB may derive the information about the UE on its own whereas in RRC_IDLE it may be the CN that receives the registration update message and can inform/trigger the gNB to go into non-NES mode or, alternately, not allow the gNB to operate in a NES mode while the UE is there. This is depicted in FIG. 1.

FIG. 1 illustrates operations and communications of a legacy UE, serving NG-RAN, and CN through which the CN detects the legacy UE, and the NG-RAN node restores to normal state (i.e. not in NES operation), in accordance with some embodiments of the present disclosure.

In step 1001, the UE 112 communicates with the CN 106, e.g., an AMF, to perform registration area update operations. In step 1002, the CN 106 detects that the UE 112 is a legacy UE (i.e., the UE does not support NES features). In step 1003, the CN 106 communicates with the serving NG-RAN 110 indicating to the serving NG-RAN 110 that the serving NG-RAN 110 has to operate in normal state (i.e., not running NES). In step 1004, the serving NG-RAN 110 processes the information and restores the related cells into normal operation.

In step 1005, the UE 112 is served. In step 1006, the serving NG-RAN 110 may inform the neighboring cells to restore to the normal operation (e.g., according to UE position and estimates the handover target). In step 1007, when the last legacy UE has left, the serving NG-RAN 110 goes back to NES state.

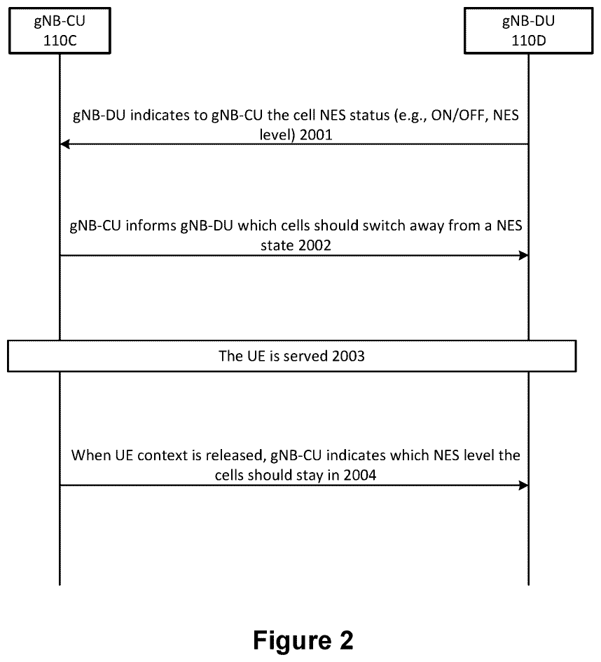

FIG. 2 illustrates operations and communications of a gNB-CU (centralizing unit) and gNB-DU (distributing unit) in the split NG-RAN architecture, in accordance with some embodiments of the present disclosure.

In step 2001, the gNB-DU 110D communicates with the gNB-CU 110C to indicate to the gNB-CU 110C the cell NES status (e.g., ON/OFF, NES level). In step 2002, the gNB-CU 110C communicates with the gNB-DU 110D to inform the gNB-DU 110D which cells should switch away from a NES state. In step 2003, the UE is served. In step 2004, when UE context is released, gNB-CU indicates which NES level the cells should stay in.

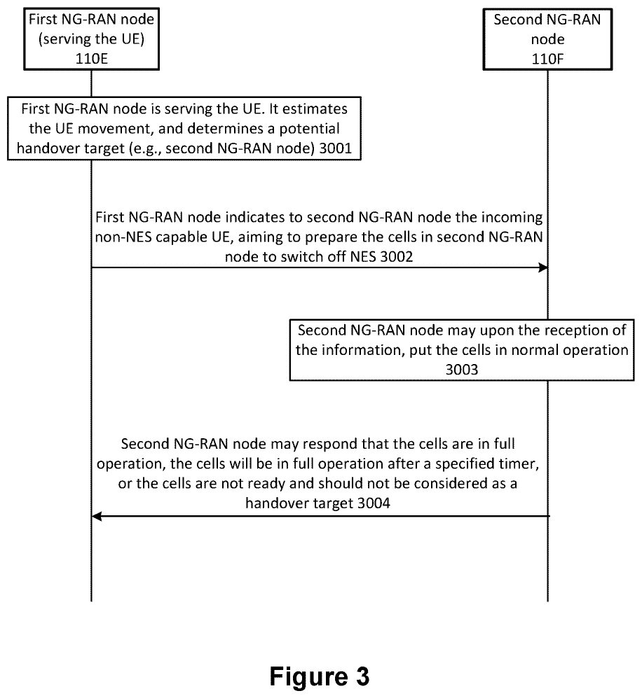

FIG. 3 illustrates operations and communications of a first NG-RAN node 110E (serving the UE) and a second NG-RAN node 110F as the first NG-RAN node 110E prepares the second NG-RAN node 110F (a neighboring NG-RAN) as a handover target.

In step 3001, the first NG-RAN node 110E is serving the UE. It estimates the UE movement, and determines a potential handover target (e.g., second NG-RAN node 110E). In step 3002, the first NG-RAN node 110F communicates with the second NG-RAN node 110F, indicating to the second NG-RAN node 110F the incoming non-NES capable UE, aiming to prepare the cells in second NG-RAN node 110F to switch off NES.

In step 3003, the second NG-RAN node 100F may, upon reception of the information, put the cells in normal operation. In step 3004, the second NG-RAN node 100F communicates with the first NG-RAN node 110E, responding that the cells are in full operation, the cells will be in full operation after a specified timer, or the cells are not ready and should not be considered as a handover target.

Going back to NES-mode, in some embodiments, this may also be done by the gNB itself or triggered by other nodes. In connected mode the UE is handed over, so the information is known by the gNB itself. According to some embodiments, if the UE in RRC_INACTIVE roams into another neighbor node (with another registration area) and triggers a connection, the neighbor node may want to fetch the UE context from the first node. Based on the context fetched, the first node may know that this UE has left the cell it was in. Alternately, according to some embodiments, if the UE is in RRC_IDLE mode and roams into a neighbor where a registration update procedure is triggered towards CN, the CN then may inform the first gNB that the UE has left that node. The first gNB may keep the list of non-NES capable UEs released to RRC_Idle by some UE Identity for the purpose of such release information exchange. Alternately, gNB is allowed to go back to NES mode if no more UEs are in that cell based on CN knowledge.

In some embodiments, when non-NES capable UE is released to RRC_Idle, gNB may release the UE with redirect to an appointed cell/frequency that is planned to be able to provide certain service to the UE. UE may perform cell reselection. When the last non-NES capable UE is released, gNB can put the cells in NES mode.

In some embodiments, when all of the non-NES capable UEs in the cell are released to RRC_Idle, the cells can be put into semi-NES mode to help ensure that the UEs can be paged. The cells may be put into the complete NES mode when the UEs have left.

It should be noted that the NES-capable UEs registration areas may be tailored such that they do not also contribute to registration update procedures.

### Third Set of Embodiments

The third set of embodiments is directed to allowing roaming of a non-NES-capable UE to a NES-cell, where the NES-cell continues operating in a NES manner but modifies certain procedures towards that UE.

In this set of embodiments, a NW node allows a non-NES-capable (legacy) UE to connect and operate at the cell as “best effort” (i.e. using legacy procedures and signal availability assumptions). The NES-capable cell continues NES operation regarding one or more NES features with all NES-capable UEs connected or camping on the cell. The NES-capable cell adopts a special handling of legacy UEs so that NES features do not interfere with these UEs, or the gNB does not respond critically to inaccuracies resulting from UE operation that is unaware of NES features. This third set of embodiments may be applied to both connected and idle/inactive mode operation.

In some embodiments, the NW node (gNB) may modify its criteria for declaring out-of-synchronization (OOS) or radio link failure (RLF) for the UE when the UE does not perform uplink (UL) transmissions, does not receive and/or acknowledge DL data, does not perform or report measurements, etc., according to procedures configured according to NES specifications. Such features may include port/CSI-RS adaptation, DL TX power adaptation, DTRX timeline adaptations, etc. The OOS or RLF thresholds, timers, etc. may be relaxed so that they are not triggered due to the UE violating related rules due to legacy operation assumptions.

In some embodiments, the NES-mode gNB may modify data transmission scheduling or link adaptation for the legacy UE. The gNB may select scheduling occasions that are valid according to legacy UE operation assumptions and omit occasions that are invalid. The gNB may also adjust (e.g. lower) the channel quality or other CSI-related assumptions during link adaptation to the UE (e.g. to compensate for the non-legacy-compatible changes in port configurations), DL power levels, etc. The gNB may also maintain awareness that the received CSI reports may be inconsistent/biased and compensate or apply robust transmission modes.

In some embodiments, paging adaptation may be applied so that non-NES-aware UEs can be packed near SSBs using legacy paging frames (PFs) and NES-aware UEs can be moved closer to SSBs using new PF mappings according to NES specifications.

In some embodiments, the UE reports its UE capability, indicating lack of NES support, to the CN at the time of initial connection or capability update, and the CN inform the NES-capable gNB of the lack of NES support for the UE in question.

In some embodiments, the gNB may observe the UE behavior and detect behaviors consistent with lack of support for one or more NES features (e.g., due to exhibiting legacy behaviors as described above. The gNB may then treat the UE as a legacy/non-NES UE and apply the protocol modifications described in this set of embodiments.

In some embodiments, a cell operating according to this method may configure a subset of NES features whose non-backwards-compatible effects are not functionally severe although they may affect performance (e.g., port/CSI-RS adaptation), or where parallel mechanisms exist for legacy and NES-capable UEs (e.g., paging consolidation). In such embodiments, the gNB may abstain from applying NES features that preclude a legacy UE connecting to the cell (e.g., modifications to SSB or SI structures).

In some embodiments, this third set of embodiments may be applied as a temporary solution for the transition period from when NES features appear in NWs until many UEs will be NES-capable.

In some embodiments, the non-NES-capable UE may be a legacy UE that is not capable of any NES technique, a legacy UE that is not capable of certain NES techniques, or a UE that is not a legacy UE but is not able to support certain NES techniques.

In some embodiments, the NES-capable node is a node (e.g., gNB) that is capable of at least one NES technique.

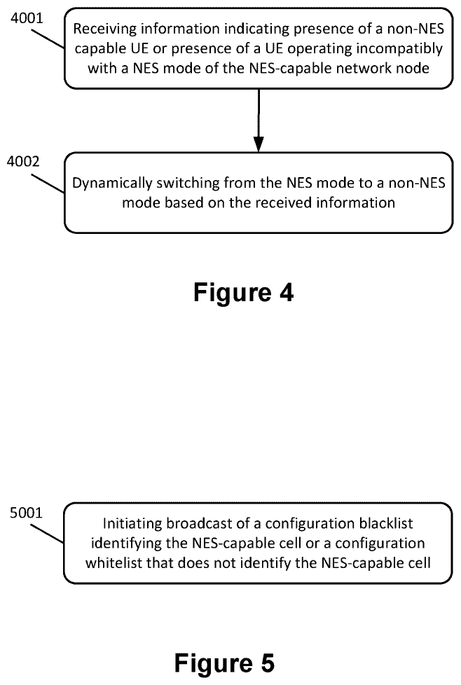

FIG. 4 illustrates a flow chart of operations that can be implemented by a first network energy saving (NES)-capable network node in accordance with some embodiments of the present disclosure.

Referring to FIG. 4, the operations implemented by the first NES-capable network node include receiving 4001 information indicating presence of a non-NES capable user equipment (UE) or presence of a UE operating incompatibly with a NES mode of the NES-capable network node. The operations further include dynamically switching 4002 from the NES mode to a non-NES mode based on the received information.

In some further embodiments, the dynamic switching 4002 from the NES mode to the non-NES mode includes switching from the NES mode to a combination of the NES mode and the non-NES mode. The switching 4002 from the NES mode to the combination of the NES mode and the non-NES mode, includes ceasing use of discontinuous transmit/receive, DTRX, while continuing use of lightweight Synchronization Signal Blocks (SSBs).

In some further embodiments, the dynamic switching 4002 is triggered by the first NES capable network node or by another network node. The other network node may be a core network node or a neighboring node that is a second NES-capable network node or is a non-NES-capable network node.

In some further embodiments, the first NES-capable network node is in communication with a neighbor radio access network (RAN) node and the operations further includes receiving from the neighbor RAN node, during a handover request, an indication that a non-NES-capable UE requests handover. The first NES-capable network node determines whether to accept or decline handover of the non-NES-capable UE.

In some further embodiments, the operations further comprise receiving from the neighbor RAN node information indicating the first NES-capable network node should dynamically switch from a NES mode to a non-NES mode in order to accept handover of the non-NES-capable UE. The information is received from the neighbor RAN node based on a service served and a predicted movement of the non-NES-capable UE.

In some further embodiments, the receiving 4001 information indicating presence of a non-NES capable UE or presence of a UE operating incompatibly with a NES mode of the NES-capable network node, includes detecting whether the UE is in a RRC_Idle/Inactive mode based on the UE's initiation of registration update procedures.

In some further embodiments, the receiving 4001 information indicating presence of a non-NES capable UE or presence of a UE operating incompatibly with a NES mode of the NES-capable network node, includes detecting, after a routing area update (RAU) or RAN update procedure, whether the UE is in a RRC_Idle/Inactive mode based on information received when the UE is paged or is requested for data transmission.

In some further embodiments, the operations further comprise initiating a registration update procedure in a NES-capable cell based on at least one of a cell identity, tracking area code, or RAN area code and based on a non-NES-capable UE registration configuration.

In some further embodiments, the operations further comprise receiving initiation of a UE registration procedure from the UE or from a second network node.

In some further embodiments, the operations further comprise receiving further information indicating ceasing of presence of the non-NES capable UE or the UE operating incompatibly with the NES mode of the NES-capable network node, and dynamically switching from non-NES mode to the NES mode based on the further information.

In some further embodiments, the operations further comprise providing to a second NES-capable network node during a handover procedure, an indication of a NES technique supported by the non-NES capable UE.

In some further embodiments, the first NES-capable node inludes a gNB and is capable of at least one NES technique.

In some further embodiments, the dynamic switching 4002 from the NES mode to the non-NES mode includes modifying one or more functions and/or features of the NES mode to become compatible with operation of the non-NES capable UE. The one or more functions and/or features of the NES mode are used without the modification for communications with NES-capable UEs served by the NES-capable network node.

In some further embodiments, the receiving 4001 of the information indicating presence of the non-NES capable UE or presence of a UE operating incompatibly with a NES mode of the NES-capable network node, includes receiving signaling from a core network indicating UE support for NES capabilities.

In some further embodiments, the receiving 4001 of the information indicating presence of the non-NES capable UE or presence of a UE operating incompatibly with a NES mode of the NES-capable network node, includes observing behaviors of the non-NES capable UE that are indicative of lacking NES feature support.

In some further embodiments, the modifying one or more functions and/or features of the NES mode to become compatible with operation of the non-NES capable UE, includes relaxing out-of-synchronization, OOS, criteria and/or radio link failure, RLF, criteria.

In some further embodiments, the one or more functions and/or features of the NES mode comprise discontinuous transmit/receive, DTRX, and/or paging occasion consolidation.

FIG. 5 illustrates a flowchart of operations that can be implemented in a first network node serving a non-network energy saving, NES,-capable cell that at least partially overlaps a NES capable cell served by a second network node in accordance with some embodiments of the present disclosure.

Referring to FIG. 5, the operations implemented by the first network node includes initiating 5001 broadcast of a configuration blacklist identifying the NES-capable cell or a configuration whitelist that does not identify the NES-capable cell.

In some further embodiments, the initiating 5001 broadcast of a configuration blacklist identifying the NES-capable cell or a configuration whitelist that does not identify the NES-capable cell, includes: not including an identity of the NES capable cell or frequency of the NES capable cell in neighbor cell broadcast information Intra/InterFreqAllowedCellList or in dedicated message MeasObject-allowed cells; or including the identity of the NES capable cell or the frequency of the NES capable cell in neighbor cell broadcast information Intra/InterFreqExcludedCellList or in dedicated message MeasObject-excluded cells.

In some further embodiments, the initiating 5001 broadcast of a configuration blacklist identifying the NES-capable cell or a configuration whitelist that does not identify the NES-capable cell, includes initiating broadcast of an indication of one or more NES techniques applicable to the configuration blacklist.

Example operations directed to the first set of embodiments is further described below.

A first network Energy Saving (NES)-capable node (gNB) dynamically switches from NES to non-NES mode (fully or partially) based on detection of non-NES-capable UE.

According to some embodiments, the fully or partially switch from NES to non-NES mode implies to the level that does not impact or has minor impact on operation of non-NES-capable UE in a NES-capable node (e.g., gNB may stop using NW DTRX in case it affects Idle non-NES-capable UEs, while still operating in a NES-mode towards NES-capable UEs in connected mode).

According to some embodiments, the switching, or permission for whether a certain mode is allowed, is triggered by the first NES-capable node itself or by another node (e.g., by a CN node, or by another neighboring node). The indication from another node can be communicated over gNB-CN or gNB-gNB interfaces.

According to some embodiments, in connected mode a third neighbor RAN node may inform the first NES-capable node (e.g., RAN node) during a handover request that a non-NES-capable UE needs handover which the first NES-capable node may choose to accept/decline. Depending on the service served and the predication of the UE movements, the serving NG-RAN node may inform the neighboring cell which is the potential handover target to switch away from the NES mode, referring to FIG. 3.

According to some embodiments, the detection of UEs in RRC_Idle/Inactive is based on UE's initiation of registration update procedures (e.g., Registration Area Update in RRC_IDLE or RNA Update Procedure in RRC_INACTIVE states). Alternatively, such detection could be, after RAU or RAN update procedure, when the UE is paged, or is requested for data transmission (RRC Inactive).

According to some embodiments, the Cell Identity and/or Tracking Area Code and/or RAN Area Code of the cell of first NES-capable node in combination with a non-NES-capable UE's registration configuration leads to a registration update procedure in NES-capable cell.

According to some embodiments, the UE's registration procedure is either towards the first NES-capable node (e.g., the gNB, gNB-CU) or a second node (e.g., the CN, AMF).

According to some embodiments, if the UE is a non-NES-capable UE, the first NES-capable node itself, or based on information/command from the second node, stops operating in a NES-mode if such NES-mode is incompatible with non-NES-capable UEs operation (e.g., the second node can inform the first NES-capable node over interfaces of the non-NES capable UE capabilities and thereby the NES node can decide what NES features should be turned off so the legacy UE can camp on it).

According to some embodiments, the NW operates in a non-NES mode while the non-NES-capable UE is camping on the first NES-capable node, or on a NES mode which can be handled by a legacy UE.

According to some embodiments, the NW may revert to NES-mode when the last non-NES-capable UE leaves the first NES-capable node.

According to some embodiments, the leaving of the non-NES-capable UE is detected either by the first NES-capable node (e.g., if UE has left to a neighboring cell, and the UE's inactive context is fetched away from the first node), or the first NES-capable node is informed by a second node (e.g., if UE roams into a neighbor, performs a registration update procedure to CN, and the CN informs the first node that UE has left).

According to some embodiments, when the nodes exchange the information about the non-NES-capable UEs for the purpose of handover (or any other purpose), they can specify exactly which NES techniques non-NES-capable UEs support (or do not support).

Some embodiments herein can be applicable at the level of a particular NES technique, where the NW may use multiple NES techniques at the same time (e.g., technique A and technique B) as long as each UE that is being served by a particular node or a cell supports each of the techniques that the node/cell uses at the given time.

In one example the NW uses NES techniques A and B when, for example, a UE N incapable of NES technique A, but capable of NES technique B registers in the NW. Upon the detection of UE N, the NW changes the set of NES techniques it applies (e.g., stops using NES technique A and continues using NES technique B).

In another example the NW uses NES techniques A and B when, for example, a UE N incapable of both NES techniques A and B, registers in the NW. Upon the detection of UE N, the NW stops using NES techniques A and B and continues working in a non-NES mode until the set of registered UEs changes such that they all support at least one of the NES techniques that a particular node/cell is capable of.

In yet another example the NW uses NES techniques A and B when, for example, a UE N incapable of both NES techniques A and B, but capable of technique C registers in the NW. Upon the detection of UE N, the NW stops using NES techniques A and B and starts using NES technique C if each UE in the set of registered UEs (i.e., including all UEs registered before UE N and UE N) supports.

The above embodiments and examples can be applicable at the level of a node (e.g., gNB) or at the level of a cell.

Example operations directed to the second set of embodiments is further described below.

A first NW RAN node that can serve non-NES-capable UEs, in neighbor of a second NES-capable RAN node that cannot (or configured not to) serve non-NES-capable UEs (e.g., there exists already overlapping coverage for handling non-NES-capable UEs). The first RAN node in its broadcast/dedicated configuration blacklists (or not whitelists) NES-capable cells.

According to some embodiments, such blacklisting is done through one or more of:
i—not including the identity of the second node's cell or frequency in broadcast neighbor cell info Intra/InterFreqAllowedCellList, or dedicated message's MeasObject-allowed cells; or
ii—including the identity of the second node's cell or frequency in neighbor cell broadcast info Intra/InterFreqExcludedCellList, or dedicated message's MeasObject-excluded cells.

According to some embodiments, a new set of optional white/black-listing parameters are introduced and broadcast from the first RAN node specifically for (which can be interpreted by) NES-capable UEs.

According to some embodiments, an operation in a NES-capable UE which in the first RAN node obeys the said NES-specific set of parameters in order to know if a neighboring cell is white/black-listed in case they are present.

According to some embodiments, these operations can be applicable at the level of a particular NES technique. In one example, a blacklist of NES capable cells is per NES technique. In another example, a blacklist of NES capable cells is for multiple NES techniques, but for each cell it is specified which NES techniques it supports.

Example operations directed to the third set of embodiments is further described below.

A first network Energy Saving (NES)-capable node (gNB), based on detection of a non-NES-capable UE, dynamically modifies its procedures in one or more functions/features with reference to the UE to account for UE behaviors that are inconsistent with one or more NES features.

According to some embodiments, the first NES-capable node remains in NES-consistent operation with reference to other NES-supporting UEs in the cell.

According to some embodiments the detection includes signaling from the CN about UE capabilities (regarding NES support) of the UE.

According to some embodiments, the detection includes observing behaviors of the UE that are consistent with lack of NES feature support.

According to some embodiments, the procedure modifications comprise one or more of relaxing OOS or RLF criteria (including a specific relaxed configuration of associated parameters for that specific UE) in response with missed transmissions, acknowledgements, or reporting, allocation of Pos, etc.

According to some embodiments, the NES features comprise one or more of gNB DTRX, paging occasion consolidation, etc.

A listing of example Embodiments according to some embodiments of the present disclosure is provided below:

1. A method implemented in a first network energy saving (NES)-capable network node comprising:
receiving (4001) information indicating presence of a non-NES capable user equipment (UE) or presence of a UE operating incompatibly with a NES mode of the NES-capable network node; and
dynamically switching (4002) from the NES mode to a non-NES mode based on the received information.
   2. The method of Embodiment 1, wherein the dynamic switching (4002) from the NES mode to the non-NES mode comprises switching from the NES mode to a combination of the NES mode and the non-NES mode.
   3. The method of Embodiment 2, wherein the dynamic switching (4002) from the NES mode to the combination of the NES mode and the non-NES mode, comprises ceasing use of discontinuous transmit/receive, DTRX, while continuing use of lightweight Synchronization Signal Blocks (SSBs).
   4. The method of any of Embodiments 1 to 3, wherein the dynamic switching (4002) is triggered by the first NES capable network node or by another network node.
   5. The method of Embodiment 4, wherein the other network node is a core network node or a neighboring node that is a second NES-capable network node or is a non-NES-capable network node.
   6. The method of any of Embodiments 1 to 5, wherein the first NES-capable network node is in communication with a neighbor radio access network (RAN) node, wherein the method further comprises:
receiving from the neighbor RAN node, during a handover request, an indication that a non-NES-capable UE requests handover.
   7. The method of Embodiment 6, wherein the first NES-capable network node determines whether to accept or decline handover of the non-NES-capable UE.
   8. The method of any of Embodiments 6 to 7, further comprising:
receiving from the neighbor RAN node information indicating the first NES-capable network node should dynamically switch from a NES mode to a non-NES mode in order to accept handover of the non-NES-capable UE, wherein the information is received from the neighbor RAN node based on a service served and a predicted movement of the non-NES-capable UE.
   9. The method of any of Embodiments 1 to 8, wherein the receiving (4001) information indicating presence of a non-NES capable UE or presence of a UE operating incompatibly with a NES mode of the NES-capable network node, comprises:
detecting whether the UE is in a RRC_Idle/Inactive mode based on the UE's initiation of registration update procedures.
   10. The method of any of Embodiments 1 to 9, wherein the receiving (4001) information indicating presence of a non-NES capable UE or presence of a UE operating incompatibly with a NES mode of the NES-capable network node, comprises:
detecting, after a routing area update (RAU) or RAN update procedure, whether the UE is in a RRC_Idle/Inactive mode based on information received when the UE is paged or is requested for data transmission.
   11. The method of any of Embodiments 1 to 10, further comprising:
initiating a registration update procedure in a NES-capable cell based on at least one of a cell identity, tracking area code, or RAN area code and based on a non-NES-capable UE registration configuration.
   12. The method of Embodiment 11, further comprising:
receiving initiation of a UE registration procedure from the UE or from a second network node.
   13. The method of Embodiments 1 to 12, further comprising:
receiving further information indicating ceasing of presence of the non-NES capable UE or the UE operating incompatibly with the NES mode of the NES-capable network node; and
dynamically switching from non-NES mode to the NES mode based on the further information.
   14. The method of Embodiments 1 to 13, further comprising:
providing to a second NES-capable network node during a handover procedure, an indication of a NES technique supported by the non-NES capable UE.
   15. The method of any of Embodiments 1 to 14, wherein the first NES-capable node comprises a gNB and is capable of at least one NES technique.
   16. The method of any of Embodiments 1 to 15, wherein the dynamic switching (4002) from the NES mode to the non-NES mode comprises modifying one or more functions and/or features of the NES mode to become compatible with operation of the non-NES capable UE.
   17. The method of Embodiment 16, wherein the one or more functions and/or features of the NES mode are used without the modification for communications with NES-capable UEs served by the NES-capable network node.
   18. The method of any of Embodiments 16 to 17, wherein the receiving (4001) of the information indicating presence of the non-NES capable UE or presence of a UE operating incompatibly with a NES mode of the NES-capable network node, comprises:
receiving signaling from a core network indicating UE support for NES capabilities.
   19. The method of any of Embodiments 16 to 18, wherein the receiving (4001) of the information indicating presence of the non-NES capable UE or presence of a UE operating incompatibly with a NES mode of the NES-capable network node, comprises:
observing behaviors of the non-NES capable UE that are indicative of lacking NES feature support.
   20. The method of any of Embodiments 16 to 19, wherein the modifying one or more functions and/or features of the NES mode to become compatible with operation of the non-NES capable UE, comprises:
relaxing out-of-synchronization, OOS, criteria and/or radio link failure, RLF, criteria.
   21. The method of any of Embodiments 16 to 20, wherein the one or more functions and/or features of the NES mode comprise discontinuous transmit/receive, DTRX, and/or paging occasion consolidation.
   22. A method implemented in a first network node serving a non-network energy saving, NES,-capable cell that at least partially overlaps a NES capable cell served by a second network node, the method comprising:
initiating (5001) broadcast of a configuration blacklist identifying the NES-capable cell or a configuration whitelist that does not identify the NES-capable cell.
   23. The method of Embodiment 22, wherein the initiating (5001) broadcast of a configuration blacklist identifying the NES-capable cell or a configuration whitelist that does not identify the NES-capable cell, comprises:
not including an identity of the NES capable cell or frequency of the NES capable cell in neighbor cell broadcast information Intra/InterFreqAllowedCellList or in dedicated message MeasObject-allowed cells; or
including the identity of the NES capable cell or the frequency of the NES capable cell in neighbor cell broadcast information Intra/InterFreqExcludedCellList or in dedicated message MeasObject-excluded cells.
   24. The method of any of Embodiments 22 to 23, wherein the initiating (5001) broadcast of a configuration blacklist identifying the NES-capable cell or a configuration whitelist that does not identify the NES-capable cell, comprises:
initiating broadcast of an indication of one or more NES techniques applicable to the configuration blacklist.
   25. A first network energy saving (NES)-capable network node (QQ110A, QQ110B, QQ108) configured to communicate with a plurality of user equipments, UEs, the first NES-capable network node comprising processing circuitry (QQ302) configured to:
receive information indicating presence of a non-NES capable user equipment (UE) or presence of a UE operating incompatibly with a NES mode of the NES-capable network node; and
dynamically switch from the NES mode to a non-NES mode based on the received information.
   26. The first NES-capable network node of Embodiment 25, wherein the processing circuitry of the source node is further configured to perform the method of any of Embodiments 2 to 21.
   27. A first network node (QQ110A, QQ110B, QQ108) serving a non-network energy saving, NES,-capable cell that at least partially overlaps a NES capable cell served by a second network node, the first network node comprising processing circuitry (QQ302) configured to:
initiate broadcast of a configuration blacklist identifying the NES-capable cell or a configuration whitelist that does not identify the NES-capable cell.
   28. The network node of Embodiment 27, wherein the processing circuitry of the source node is further configured to perform the method of any of Embodiments 23 to 24.
   29. A method implemented by a host configured to operate in a communication system that further includes a first network energy saving (NES)-capable network node and a plurality of user equipments, UEs, the method comprising:
providing user data for the UEs; and
initiating transmissions carrying the user data to the UEs via a cellular network comprising the network node, wherein the first NES-capable network node performs the following operations to transmit the user data from the host to the UEs:
receiving information indicating presence of a non-NES capable UE or presence of a UE operating incompatibly with a NES mode of the NES-capable network node; and
dynamically switching from the NES mode to a non-NES mode based on the received information.
   30. The method of Embodiment 29 wherein the network node is further configured to: perform the method of any of Embodiments 2 to 21.
   31. A method implemented by a host configured to operate in a communication system that further includes a first network node serving a non-network energy saving, NES,-capable cell that at least partially overlaps a NES capable cell served by a second network node, the method comprising:
initiating broadcast of a configuration blacklist identifying the NES-capable cell or a configuration whitelist that does not identify the NES-capable cell.
   32. The method of Embodiment 31 wherein the network node is further configured to:
perform the method of any of Embodiments 23 to 24.
   33. A host configured to operate in a communication system to provide an over-the-top, OTT, service, the host comprising:
processing circuitry configured to provide user data; and
a network interface configured to initiate transmissions of the the user data to a first network energy saving (NES)-capable network node in a cellular network for transmission to user equipments, UEs, the first NES-capable network node having a communication interface and processing circuitry, the processing circuitry of the first NES-capable network node configured to perform the following operations to transmit the user data from the host to the UEs:
receive information indicating presence of a non-NES capable UE or presence of a UE operating incompatibly with a NES mode of the NES-capable network node; and
dynamically switch from the NES mode to a non-NES mode based on the received information.
   34. The host of Embodiment 33, wherein the processing circuitry of the source node is further configured to:
perform the method of any of Embodiments 2 to 21.
   35. A host configured to operate in a communication system to provide an over-the-top, OTT, service, the host comprising:
processing circuitry configured to provide user data; and
a network interface configured to initiate transmissions of the the user data to a first network node serving a non-network energy saving, NES,-capable cell that at least partially overlaps a NES capable cell served by a second network node in a cellular network for transmission to user equipments, UEs, the first network node having a communication interface and processing circuitry, the processing circuitry of the first network node configured to perform the following operations to transmit the user data from the host to the UEs:
initiate broadcast of a configuration blacklist identifying the NES-capable cell or a configuration whitelist that does not identify the NES-capable cell.
   36. The host of Embodiment 35, wherein the processing circuitry of the first network node is further configured to:
perform the method of any of Embodiments 23 to 24.

As explained above, a legacy UE may try to access a NW energy saving (NES) capable cell while the NES capable cell may be configured with features that a legacy UE can be configured with or cannot operate properly with, e.g., a cell which receives its paging from another cell, or NW discontinuous transmission (DTX) or discontinuous reception (DRX).

There presently is no mechanism in order to bar (prevent) a legacy UE from accessing a NES capable cell.

Some embodiments of the present disclosure are directed to enabling deployment of NES capable cells with no or limited impact on legacy UEs. Operations according to some embodiments bar legacy UEs or non-NES capable UEs from accessing a NES capable cell when they cannot support the features which are configured for this cell.

Advantages of barring such access, include that legacy UEs or non-NES capable UEs do not increase the load on NES capable cells and also do not waste energy related to hopelessly trying to access such NES capable cells.

Additional information related to these and other embodiments is explained in the document provided in the Appendix which forms part of the present disclosure.

An important aspect that needs to be taken into consideration when designing the NES techniques is a possible impact on the legacy UEs. In the case of a NES technique that is configurable at the level of a serving cell and that affect the legacy UEs (e.g., NW DTX/DRX configurable per serving cell), embodiments of the present disclosure can be directed to operations that enhance cell barring through Master Information Block (MIB) with a cell barring through a System Information Block (SIB), e.g., SIB1 or a specific SIB for NES.

In accordance with some embodiments, for the cells that support NES features, the enhancement of cell barring through MIB with a cell barring through SIB would operate as follows. When a cell is using a NES feature that is not supported by legacy UEs it can set itself as barred in MIB. The legacy UEs incapable of the NES feature will read the MIB and understand that the cell is barred. The NES capable UEs will ignore the information regarding cell barring in MIB and read the SIB, from which they can understand whether the cell is barred or not. Observe that the cell can be barred for the NES capable UEs as well in certain cases known to the NW, e.g., during the maintenance at the NW side.

One embodiment of the present disclosure is directed to a method in a first UE to receive a first signal or a first sequence from a cell, where a bit or a flag or a signature in that signal indicates that the first UE is barred from accessing that cell.

In a further embodiment, a method in a second UE which receives the first signal or first sequence from the cell indicating that it is potentially not barred from accessing the cell, and further it receives a second signal or a second signature indicating that the second UE is not barred from accessing the cell and is permitted to try to access the cell.

In a further embodiment, the first signal or sequence is a MIB or a light weight MIB.

In another further embodiment, the cell is a NES capable cell, e.g., the cell is configured with light weight SSBs, NW DTX/DRX, etc.

In another further embodiment, the first UE is a legacy UE and/or a UE which is not a NES capable one, e.g., a UE which cannot be configured with NW DTX/DRX.

In another further embodiment, the second signal or sequence is a SIB, e.g., SIB1 or a NES SIB. Optionally, the SIB1 or a NES SIB contains only the information indicating whether the cell is barred or not for all NES capable UEs, regardless of the NES technique that the cell applies (i.e., there is no distinguishing between different NES techniques). Optionally, the SIB1 or a NES SIB contains the information indicating whether the cell is barred or not for the UEs capable of a specific NES technique (i.e., there is distinguishing between different NES techniques).

In another further embodiment, the second UE is a NES capable UE, or a UE that can be configured with NES specific features, e.g., NW DTX/DRX.

Some other embodiments are directed to a network (NW) node where it does not apply NW DTX/DRX to a certain cell that is used also by a legacy UE.

Example aspects of fields and related descriptions that can be used in accordance with various embodiments are now described below.

In the context of 3GPP 38.331, various of the above embodiments can include use of following subsections.

### MIB:

The MIB includes the system information transmitted on BCH.
Signalling radio bearer: N/A
RLC-SAP: TM
Logical channel: BCCH
Direction: Network to UE
   Example for the Embodiment 2.a from Section 6.1:

MIB

-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}
-- TAG-MIB-STOP
-- ASN1STOP

MIB field descriptions

cellBarred
Value barred means that the cell is barred, as defined in TS 38.304 [20]. This field is
ignored by IAB-MT. This field is ignored for connectivity to NTN. In accordance
with various embodiments of the present disclosure, this field is ignored by NES
capable UEs.
dmrs-TypeA-Position
Position of (first) DM-RS for downlink (see TS 38.211 [16], clause 7.4.1.1.2) and
uplink (see TS 38.211 [16], clause 6.4.1.1.3).
intraFreqReselection
Controls cell selection/reselection to intra-frequency cells when the highest ranked
cell is barred, or treated as barred by the UE, as specified in TS 38.304 [20]. This
field is ignored by IAB-MT.
pdcch-ConfigSIB1
Determines a common ControlResourceSet (CORESET), a common search space and
necessary PDCCH parameters. If the field ssb-SubcarrierOffset indicates that SIB1 is
absent, the field pdcch-ConfigSIB1 indicates the frequency positions where the UE
may find SS/PBCH block with SIB1 or the frequency range where the network does
not provide SS/PBCH block with SIB1 (see TS 38.213 [13], clause 13).
ssh-SubcarrierOffset
Corresponds to k_{SSB} (see TS 38.213 [13]), which is the frequency domain offset
between SSB and the overall resource block grid in number of subcarriers. (See TS
38.211 [16], clause 7.4.3.1). For operation with shared spectrum channel access (see
37.213 [48]), this field corresponds to k̅_{SSB}, and k_{SSB} is obtained from k̅_{SSB} (see TS
38.211 [16], clause 7.4.3.1); the LSB of this field is used also for deriving the QCL
relation between SS/PBCH blocks as specified in TS 38.213 [13], clause 4.1.
The value range of this field may be extended by an additional most significant bit
encoded within PBCH as specified in TS 38.213 [13].
This field may indicate that this cell does not provide SIB1 and that there is hence no
CORESET#0 configured in MIB (see TS 38.213 [13], clause 13). In this case, the
field pdcch-ConfigSIB1 may indicate the frequency positions where the UE may (not)
find a SS/PBCH with a control resource set and search space for SIB1 (see TS 38.213
[13], clause 13).
subCarrierSpacingCommon
Subcarrier spacing for SIB1, Msg.2/4 and MsgB for initial access, paging and
broadcast SI-messages. If the UE acquires this MIB on an FR1 carrier frequency, the
value scs15or60 corresponds to 15 kHz and the value scs30or120 corresponds to 30
kHz. If the UE acquires this MIB on an FR2 carrier frequency, the value scs15or60
corresponds to 60 kHz and the value scs30or120 corresponds to 120 kHz. For
operation with shared spectrum channel access in FR1 (see 37.213 [48]) and for
operation in FR2-2, the subcarrier spacing for SIB1, Msg.2/4 and MsgB for initial
access, paging and broadcast SI-messages is same as that for the corresponding SSB.
For operation with shared spectrum channel access, this field instead is used for
deriving the QCL relation between SS/PBCH blocks as specified in TS 38.213 [13],
clause 4.1.
systemFrameNumber
The 6 most significant bits (MSB) of the 10-bit System Frame Number (SFN). The 4
LSB of the SFN are conveyed in the PBCH transport block as part of channel coding
(i.e. outside the MIB encoding), as defined in clause 7.1 in TS 38.212 [17].

### SIB1:

SIB1 contains information relevant when evaluating if a UE is allowed to access a cell and defines the scheduling of other system information. It also contains radio resource configuration information that is common for all UEs and barring information applied to the unified access control.
Signalling radio bearer: N/A
RLC-SAP: TM
Logical channels: BCCH
Direction: Network to UE
   Example for the Embodiment 2.d.i from Section 6.1: SIB1 Message

-- ASN1START
-- TAG-SIB1-START

| | |
|---|---|
| SIB1 ::= | SEQUENCE { |
| cellSelectionInfo | SEQUENCE { |
| q-RxLevMin | Q-RxLevMin, |
| q-RxLevMinOffset | INTEGER (1..8) |

OPTIONAL, -- Need S

| | |
|---|---|
| q-RxLevMinSUL | Q-RxLevMin |

OPTIONAL, -- Need R

| | | |
|---|---|---|
| q-QualMin | Q-QualMin | OPTIONAL, - |

- Need S

| | |
|---|---|
| q-QualMinOffset | INTEGER (1..8) |

OPTIONAL -- Need S

| | |
|---|---|
| } | OPTIONAL, -- Cond Standalone |
| cellAccessRelatedInfo | CellAccessRelatedInfo, |
| connEstFailureControl | ConnEstFailureControl |

OPTIONAL, -- Need R

| | |
|---|---|
| si-SchedulingInfo | SI-SchedulingInfo |

OPTIONAL, -- Need R

| | |
|---|---|
| servingCellConfigCommon | ServingCellConfigCommonSIB |

OPTIONAL, -- Need R

| | |
|---|---|
| ims-EmergencySupport | ENUMERATED {true} |

OPTIONAL, -- Need R

| | |
|---|---|
| eCallOverIMS-Support | ENUMERATED {true} |

OPTIONAL, -- Need R

| | |
|---|---|
| ue-TimersAndConstants | UE-TimersAndConstants |

OPTIONAL, -- Need R

| | |
|---|---|
| uac-BarringInfo | SEQUENCE { |
| uac-BarringForCommon | UAC-BarringPerCatList |

OPTIONAL, -- Need S

| | |
|---|---|
| uac-BarringPerPLMN-List | UAC-BarringPerPLMN-List |

OPTIONAL, -- Need S

| | |
|---|---|
| uac-BarringInfoSetList | UAC-BarringInfoSetList, |
| uac-AccessCategory1-SelectionAssistanceInfo | CHOICE { |
| plmnCommon | UAC-AccessCategory1-SelectionAssistanceInfo, |
| individualPLMNList | SEQUENCE (SIZE (2..maxPLMN)) OF UAC- |

AccessCategory1-SelectionAssistanceInfo

| | |
|---|---|
| } | OPTIONAL -- Need S |
| } | OPTIONAL, -- Need R |
| useFullResumeID | ENUMERATED {true} |

OPTIONAL, -- Need R

| | |
|---|---|
| lateNonCriticalExtension | OCTET STRING |

OPTIONAL,

| | |
|---|---|
| nonCriticalExtension | SIB1-v1610-IEs |

OPTIONAL
}

| | |
|---|---|
| SIB1-v1610-IEs ::= | SEQUENCE { |
| idleModeMeasurementsEUTRA-r16 | ENUMERATED{true} |

OPTIONAL, -- Need R

| | |
|---|---|
| idleModeMeasurementsNR-r16 | ENUMERATED{true} |

OPTIONAL, -- Need R

| | |
|---|---|
| posSI-SchedulingInfo-r16 | PosSI-SchedulingInfo-r16 |

OPTIONAL, -- Need R

| | |
|---|---|
| nonCriticalExtension | SIB1-v1630-IEs |

OPTIONAL
}

| | |
|---|---|
| SIB1-v1630-IEs ::= | SEQUENCE { |
| uac-BarringInfo-v1630 | SEQUENCE { |
| uac-AC1-SelectAssistInfo-r16 | SEQUENCE (SIZE (2..maxPLMN)) OF UAC-AC1- |

SelectAssistInfo-r16

| | |
|---|---|
| } | OPTIONAL, -- Need R |
| nonCriticalExtension | SIB1-v1700-IEs |

OPTIONAL
}

| | |
|---|---|
| SIB1-v1700-IEs ::= | SEQUENCE { |
| hsdn-Cell-r17 | ENUMERATED {true} |

OPTIONAL, -- Need R

| | |
|---|---|
| uac-BarringInfo-v1700 | SEQUENCE { |
| uac-BarringInfoSetList-v1700 | UAC-BarringInfoSetList-v1700 |
| } | OPTIONAL, -- Cond MINT |
| sdt-ConfigCommon-r17 | SDT-ConfigCommonSIB-r17 |

OPTIONAL, -- Need R

| | |
|---|---|
| redCap-ConfigCommon-r17 | RedCap-ConfigCommonSIB-r17 |

OPTIONAL, -- Need R

| | |
|---|---|
| featurePriorities-r17 | SEQUENCE { |
| redCapPriority-r17 | FeaturePriority-r17 |

OPTIONAL, -- Need R

| | | |
|---|---|---|
| slicingPriority-r17 | FeaturePriority-r17 | OPTIONAL, |

-- Need R

| | |
|---|---|
| msg3-Repetitions-Priority-r17 | FeaturePriority-r17 |

OPTIONAL, -- Need R

| | | |
|---|---|---|
| sdt-Priority-r17 | FeaturePriority-r17 | OPTIONAL |

-- Need R

| | |
|---|---|
| } | OPTIONAL, -- Need R |
| si-SchedulingInfo-v1700 | SI-SchedulingInfo-v1700 |

OPTIONAL, -- Need R

| | |
|---|---|
| hyperSFN-r17 | BIT STRING (SIZE (10)) |

OPTIONAL, -- Need R

| | |
|---|---|
| eDRX-AllowedIdle-r17 | ENUMERATED {true} |

OPTIONAL, -- Need R

| | |
|---|---|
| eDRX-AllowedInactive-r17 | ENUMERATED {true} |

OPTIONAL, -- Cond EDRX-RC

| | |
|---|---|
| intraFreqReselectionRedCap-r17 | ENUMERATED {allowed, notAllowed} |

OPTIONAL, -- Need S

| | |
|---|---|
| cellBarredNTN-r17 | ENUMERATED {barred, notBarred} |

OPTIONAL, -- Need S

| | |
|---|---|
| cellBarredNES-r18 | ENUMERATED {barred, notBarred} [According to some |
| embodiments] | OPTIONAL, -- Need S [According to some |

embodiments]

| | |
|---|---|
| nonCriticalExtension | SEQUENCE { } |

OPTIONAL
}

| | |
|---|---|
| UAC-AccessCategory1-SelectionAssistanceInfo ::= | ENUMERATED {a, b, c} |

| | |
|---|---|
| UAC-AC1-SelectAssistInfo-r16 ::= | ENUMERATED {a, b, c, notConfigured} |
| SDT-ConfigCommonSIB-r17 ::= | SEQUENCE { |
| sdt-RSRP-Threshold-r17 | RSRP-Range |

OPTIONAL, -- Need R

| | |
|---|---|
| sdt-LogicalChannelSR-DelayTimer-r17 | ENUMERATED { sf20, sf40, sf64, sf128, |
| sf512, sf1024, sf2560, spare1} | OPTIONAL, -- Need R |
| sdt-DataVolumeThreshold-r17 | ENUMERATED {byte32, byte100, byte200, |

byte400, byte600, byte800, byte1000, byte2000, byte4000,

byte8000, byte9000, byte10000, byte12000, byte24000,

byte48000, byte96000},

| | |
|---|---|
| t319a-r17 | ENUMERATED { ms100, ms200, ms300, ms400, ms600, |

ms1000, ms2000,

ms3000, ms4000, spare7, spare6, spare5, spare4, spare3,

spare2, spare1}
}

| | |
|---|---|
| RedCap-ConfigCommonSIB-r17 ::= | SEQUENCE { |
| halfDuplexRedCapAllowed-r17 | ENUMERATED {true} |

OPTIONAL, -- Need R

| | |
|---|---|
| cellBarredRedCap-r17 | SEQUENCE { |
| cellBarredRedCap1Rx-r17 | ENUMERATED {barred, notBarred}, |
| cellBarredRedCap2Rx-r17 | ENUMERATED {barred, notBarred} |
| } | OPTIONAL, -- Need R |

...
}
FeaturePriority-r17 ::= INTEGER (0..7)
-- TAG-SIB1-STOP
-- ASN1STOP

SIB1 field descriptions

cellBarredNTN
Value barred means that the cell is barred for connectivity to NTN, as defined in TS
38.304 [20]. Value notBarred means that the cell is allowed for connectivity to NTN.
If not present, the UE considers the cell is not allowed for connectivity to NTN, as
defined in TS 38.304 [20]. This field is only applicable to NTN-capable UEs.
cellBarredNES
Value barred means that the cell is barred for a NES capable UE, as defined in TS
38.304 [20]. Value notBarred means that the cell is allowed for a NES capable UE. If
not present, the NES capable UE considers the cell is not allowed, as defined in TS
38.304 [20]. This field is only applicable to NES-capable UEs. This field description
is defined in accordance with various embodiments of the present disclosure.
cellBarredRedCap1Rx
Value barred means that the cell is barred for a RedCap UE with 1 Rx branch, as
defined in TS 38.304 [20]. This field is ignored by non-RedCap UEs.
cellBarredRedCap2Rx
Value barred means that the cell is barred for a RedCap UE with 2 Rx branches, as
defined in TS 38.304 [20]. This field is ignored by non-RedCap UEs.
cellSelectionInfo
Parameters for cell selection related to the serving cell.
eCallOverIMS-Support
Indicates whether the cell supports eCall over IMS services as defined in TS 23.501
[32]. If absent, eCall over IMS is not supported by the network in the cell.
eDRX-AllowedIdle
The presence of this field indicates that extended DRX is allowed in the cell for UEs
in RRC_IDLE. The UE shall stop using extended DRX in RRC_IDLE if eDRX-
AllowedIdle is not present.
eDRX-AllowedInactive
The presence of this field indicates that extended DRX is allowed in the cell for UEs
in RRC_INACTIVE. The UE shall stop using extended DRX in RRC_INACTIVE if
eDRX-AllowedInactive is not present.
featurePriorities
Indicates priorities for features, such as RedCap, Slicing, SDT and MSG3-Repetitions
for Coverage Enhancements. These priorities are used to determine which
FeatureCombinationPreambles the UE shall use when a feature maps to more than
one FeatureCombinationPreambles, as specified in TS 38.321 [3]. A lower value
means a higher priority. The network does not signal the same priority for more than
one feature. The network signals a priority for all feature that map to at least one
FeatureCombinationPreambles.
halfDuplexRedCap-Allowed
The presence of this field indicates whether the cell supports half-duplex FDD
RedCap UEs.
hsdn-Cell
This field indicates this is a HSDN cell as specified in TS 38.304 [20].
hyperSFN
Indicates hyper SFN which increments by one when the SFN wraps around.
idleModeMeasurementsEUTRA
This field indicates that a UE that is configured for EUTRA idle/inactive
measurements shall perform the measurements while camping in this cell and report
availability of these measurements when establishing or resuming a connection in this
cell. If absent, a UE is not required to perform EUTRA idle/inactive measurements.
idleModeMeasurementsNR
This field indicates that a UE that is configured for NR idle/inactive measurements
shall perform the measurements while camping in this cell and report availability of
these measurements when establishing or resuming a connection in this cell. If absent,
a UE is not required to perform NR idle/inactive measurements.
ims-EmergencySupport
Indicates whether the cell supports IMS emergency bearer services for UEs in limited
service mode. If absent, IMS emergency call is not supported by the network in the
cell for UEs in limited service mode.
intraFreqReselectionRedCap
Controls cell selection/reselection to intra-frequency cells for RedCap UEs when this
cell is barred, or treated as barred by the RedCap UE, as specified in TS 38.304 [20].
If not present, a RedCap UE treats the cell as barred, i.e., the UE considers that the
cell does not support RedCap.
q-QualMin
Parameter “Q_{qualmin}” in TS 38.304 [20], applicable for serving cell. If the field is
absent, the UE applies the (default) value of negative infinity for Q_{qualmin}.
q-QualMinOffset
Parameter “Q_{qualminoffset}” in TS 38.304 [20]. Actual value Q_{qualminoffset} = field value
[dB]. If the field is absent, the UE applies the (default) value of 0 dB for Q_{qualminoffset}.
Affects the minimum required quality level in the cell.
q-RxLevMin
Parameter “Qᵣₓₗₑᵥₘᵢₙ” in TS 38.304 [20], applicable for serving cell.
q-RxLevMinOffset
Parameter “Q_{rxlevminoffset}” in TS 38.304 [20]. Actual value Q_{rxlevminoffset} = field value * 2
[dB]. If absent, the UE applies the (default) value of 0 dB for Q_{rxlevminoffset}. Affects the
minimum required Rx level in the cell.
q-RxLevMinSUL
Parameter “Qᵣₓₗₑᵥₘᵢₙ” in TS 38.304 [20], applicable for serving cell.
sdt-RSRP-Threshold
RSRP threshold used to determine whether SDT procedure can be initiated, as
specified in TS 38.321 [3].
sdt-DataVolumeThreshold
Data volume threshold used to determine whether SDT can be initiated, as specified
in TS 38.321 [3]. Value byte 32 corresponds to 32 bytes, value byte100 corresponds to
100 bytes, and so on.
sdt-LogicalChannelSR-DelayTimer
The value of logicalChannelSR-DelayTimer applied during SDT for logical channels
configured with SDT, as specified in TS 38.321 [3]. Value in number of subframes.
Value sf20 corresponds to 20 subframes, sf40 corresponds to 40 subframes, and so on.
If this field is not configured, then logicalChannelSR-DelayTimer is not applied for
SDT logical channels.
servingCellConfigCommon
Configuration of the serving cell.
t319a
Initial value of the timer T319a. Value ms100 corresponds to 100 milliseconds, value
ms200 corresponds to 200 milliseconds and so on.
uac-AccessCategory1-SelectionAssistanceInfo
Information used to determine whether Access Category 1 applies to the UE, as
defined in TS 22.261 [25]. If plmnCommon is chosen, the UAC-AccessCategory1-
SelectionAssistanceInfo is applicable to all the PLMNs and SNPNs in plmn-
IdentityInfoList and npn-IdentityInfoList. If individualPLMNList is chosen, the 1^{st}
entry in the list corresponds to the first network within all of the PLMNs and SNPNs
across the plmn-IdentityList and the npn-IdentityInfoList, the 2^{nd} entry in the list
corresponds to the second network within all of the PLMNs and SNPNs across the
plmn-IdentityList and the npn-IdentityInfoList and so on. If uac-AC1-SelectAssistInfo-
r16 is present, the UE shall ignore the uac-AccessCategory1-SelectionAssistanceInfo.
uac-AC1-SelectAssistInfo
Information used to determine whether Access Category 1 applies to the UE, as
defined in TS 22.261 [25]. The 1^{st} entry in the list corresponds to the first network
within all of the PLMNs and SNPNs across the plmn-IdentityList and npn-
IdentityInfoList, the 2^{nd} entry in the list corresponds to the second network within all
of the PLMNs and SNPNs across the plmn-IdentityList and the npn-IdentityInfoList
and so on. Value notConfigured indicates that Access Category1 is not configured for
the corresponding PLMN/SNPN.
uac-BarringForCommon
Common access control parameters for each access category. Common values are
used for all PLMNs/SNPNs, unless overwritten by the PLMN/SNPN specific
configuration provided in uac-BarringPerPLMN-List. The parameters are specified
by providing an index to the set of configurations (uac-BarringInfoSetList). UE
behaviour upon absence of this field is specified in clause 5.3.14.2.
ue-TimersAndConstants
Timer and constant values to be used by the UE. The cell operating as PCell always
provides this field.
useFullResumeID
Indicates which resume identifier and Resume request message should be used. UE
uses fullI-RNTI and RRCResumeRequest1 if the field is present, or shortI-RNTI and
RRCResumeRequest if the field is absent.

Example for the Embodiment 2.d.ii from Section 6.1:

SIB1 message

-- ASN1START
-- TAG-SIB1-START
SIB1 ::= SEQUENCE {

| | |
|---|---|
| cell SelectionInfo | SEQUENCE { |
| q-RxLevMin | Q-RxLevMin, |
| q-RxLevMinOffset | INTEGER (1..8) |

OPTIONAL, -- Need S

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| q-QualMinOffset | INTEGER (1..8) |

OPTIONAL -- Need S
}
OPTIONAL, -- Cond Standalone

| | |
|---|---|
| cellAccessRelatedInfo | CellAccessRelatedInfo, |
| connEstFailureControl | ConnEstFailureControl |

OPTIONAL, -- Need R

| | |
|---|---|
| si-SchedulingInfo | SI-SchedulingInfo |

OPTIONAL, -- Need R

| | |
|---|---|
| servingCellConfigCommon | ServingCellConfigCommonSIB |

OPTIONAL, -- Need R

| | |
|---|---|
| ims-EmergencySupport | ENUMERATED {true} |

OPTIONAL, -- Need R

| | |
|---|---|
| eCallOverIMS-Support | ENUMERATED {true} |

OPTIONAL, -- Need R

| | |
|---|---|
| ue-TimersAndConstants | UE-TimersAndConstants |

OPTIONAL, -- Need R

| | |
|---|---|
| uac-BarringInfo | SEQUENCE { |
| uac-BarringForCommon | UAC-BarringPerCatList |

OPTIONAL, -- Need S

| | |
|---|---|
| uac-BarringPerPLMN-List | UAC-BarringPerPLMN-List |

OPTIONAL, -- Need S

| | |
|---|---|
| uac-BarringInfoSetList | UAC-BarringInfoSetList, |
| uac-AccessCategory1-SelectionAssistanceInfo | CHOICE { |
| plmnCommon | UAC-AccessCategory1-SelectionAssistanceInfo, |
| individualPLMNList | SEQUENCE (SIZE (2..maxPLMN)) OF UAC- |

AccessCategory1-SelectionAssistanceInfo

| | |
|---|---|
| } | OPTIONAL -- Need S |
| } | OPTIONAL, -- Need R |
| useFullResumeID | ENUMERATED {true} |

OPTIONAL, -- Need R

| | |
|---|---|
| lateNonCriticalExtension | OCTET STRING |

OPTIONAL,

| | |
|---|---|
| nonCriticalExtension | SIB1-v1610-IEs |

OPTIONAL
}

| | |
|---|---|
| SIB1-v1610-IEs ::= | SEQUENCE { |
| idleModeMeasurementsEUTRA-r16 | ENUMERATED{true} |

OPTIONAL, -- Need R

| | |
|---|---|
| idleModeMeasurementsNR-r16 | ENUMERATED{true} |

OPTIONAL, -- Need R

| | |
|---|---|
| posSI-SchedulingInfo-r16 | PosSI-SchedulingInfo-r16 |

OPTIONAL, -- Need R

| | |
|---|---|
| nonCriticalExtension | SIB1-v1630-IEs |

OPTIONAL
}

| | |
|---|---|
| SIB1-v1630-IEs ::= | SEQUENCE { |
| uac-BarringInfo-v1630 | SEQUENCE { |
| uac-AC1-SelectAssistInfo-r16 | SEQUENCE (SIZE (2..maxPLMN)) OF UAC-AC1- |

SelectAssistInfo-r16

| | |
|---|---|
| } | OPTIONAL, -- Need R |
| nonCriticalExtension | SIB1-v1700-IEs |

OPTIONAL
}

| | |
|---|---|
| SIB1-v1700-IEs ::= | SEQUENCE { |
| hsdn-Cell-r17 | ENUMERATED {true} |

OPTIONAL, -- Need R

| | |
|---|---|
| uac-BarringInfo-v1700 | SEQUENCE { |
| uac-BarringInfoSetList-v1700 | UAC-BarringInfoSetList-v1700 |
| } | OPTIONAL, -- Cond MINT |
| sdt-ConfigCommon-r17 | SDT-ConfigCommonSIB-r17 |

OPTIONAL, -- Need R

| | |
|---|---|
| redCap-ConfigCommon-r17 | RedCap-ConfigCommonSIB-r17 |

OPTIONAL, -- Need R

| | |
|---|---|
| featurePriorities-r17 | SEQUENCE { |
| redCapPriority-r17 | FeaturePriority-r17 |

OPTIONAL, -- Need R

| | |
|---|---|
| slicingPriority-r17 | FeaturePriority-r17 |

OPTIONAL, -- Need R

| | |
|---|---|
| msg3-Repetitions-Priority-r17 | FeaturePriority-r17 |

OPTIONAL, -- Need R

| | |
|---|---|
| sdt-Priority-r17 | FeaturePriority-r17 |

OPTIONAL -- Need R
}
OPTIONAL, -- Need R

| | |
|---|---|
| si-SchedulingInfo-v1700 | SI-SchedulingInfo-v1700 |

OPTIONAL, -- Need R

| | |
|---|---|
| hyperSFN-r17 | BIT STRING (SIZE (10)) |

OPTIONAL, -- Need R

| | |
|---|---|
| eDRX-AllowedIdle-r17 | ENUMERATED {true} |

OPTIONAL, -- Need R

| | |
|---|---|
| eDRX-AllowedInactive-r17 | ENUMERATED {true} |

OPTIONAL, -- Cond EDRX-RC

| | |
|---|---|
| intraFreqReselectionRedCap-r17 | ENUMERATED {allowed, notAllowed} |

OPTIONAL, -- Need S

| | |
|---|---|
| cellBarredNTN-r17 | ENUMERATED {barred, notBarred} |

OPTIONAL, -- Need S

| | |
|---|---|
| cellBarredNESTechnique1-r18 | ENUMERATED {barred, notBarred} [Optional |

Embodiment]

| | |
|---|---|
| OPTIONAL, -- Need S | [Optional |

Embodiment]

| | |
|---|---|
| cellBarredNESTechnique2-r18 | ENUMERATED {barred, notBarred} [Optional |

Embodiment]

| | |
|---|---|
| OPTIONAL, -- Need S | [Optional |

Embodiment]

| | |
|---|---|
| ...cellBarredNESTechniqueN-r18 | ENUMERATED {barred, notBarred} [Optional |

Embodiment]
OPTIONAL, -- Need S

| | |
|---|---|
| nonCriticalExtension | SEQUENCE { } |

OPTIONAL
}

| | |
|---|---|
| UAC-AccessCategory1-SelectionAssistanceInfo ::= | ENUMERATED {a, b, c} |
| UAC-AC1-SelectAssistInfo-r16 ::= | ENUMERATED {a, b, c, notConfigured} |
| SDT-ConfigCommonSIB-r17 ::= | SEQUENCE { |
| sdt-RSRP-Threshold-r17 | RSRP-Range |

OPTIONAL, -- Need R

| | |
|---|---|
| sdt-LogicalChannelSR-DelayTimer-r17 | ENUMERATED { sf20, sf40, sf64, sf128, |
| sf512, sf1024, sf2560, spare1} | OPTIONAL, -- Need R |
| sdt-DataVolumeThreshold-r17 | ENUMERATED {byte32, byte100, byte200, |

byte400, byte600, byte800, byte1000, byte2000, byte4000,

byte8000, byte9000, byte10000, byte12000, byte24000,

byte48000, byte96000},

| | |
|---|---|
| t319a-r17 | ENUMERATED { ms100, ms200, ms300, ms400, ms600, |

ms1000, ms2000,

ms3000, ms4000, spare7, spare6, spare5, spare4, spare3,

spare2, spare1}
}

| | |
|---|---|
| RedCap-ConfigCommonSIB-r17 ::= | SEQUENCE { |
| halfDuplexRedCapAllowed-r17 | ENUMERATED {true} |

OPTIONAL, -- Need R

| | |
|---|---|
| cellBarredRedCap-r17 | SEQUENCE { |
| cellBarredRedCap1Rx-r17 | ENUMERATED {barred, notBarred}, |
| cellBarredRedCap2Rx-r17 | ENUMERATED {barred, notBarred} |
| } | OPTIONAL, -- Need R |

...
}
FeaturePriority-r17 ::= INTEGER (0..7)
-- TAG-SIB1-STOP
-- ASN1STOP

SIB1 field descriptions

cellBarredNTN
Value barred means that the cell is barred for connectivity to NTN, as defined in TS
38.304 [20]. Value notBarred means that the cell is allowed for connectivity to NTN.
If not present, the UE considers the cell is not allowed for connectivity to NTN, as
defined in TS 38.304 [20]. This field is only applicable to NTN-capable UEs.
cellBarredNESTechniquen
Value barred means that the cell is barred for a UE capable of NES technique n (n =
1, 2, . . . N), as defined in TS 38.304 [20]. Value notBarred means that the cell is
allowed for a UE capable of NES technique n (n = 1, 2, . . . N). If not present, the UE
capable of NES technique n considers the cell is not allowed, as defined in TS 38.304
[20]. This field is only applicable to UEs capable of NES technique n. This field
description is defined according to some embodiments of the present disclosure.
cellBarredRedCap1Rx
Value barred means that the cell is barred for a RedCap UE with 1 Rx branch, as
defined in TS 38.304 [20]. This field is ignored by non-RedCap UEs.
cellBarredRedCap2Rx
Value barred means that the cell is barred for a RedCap UE with 2 Rx branches, as
defined in TS 38.304 [20]. This field is ignored by non-RedCap UEs.
cellSelectionInfo
Parameters for cell selection related to the serving cell.
eCallOverIMS-Support
Indicates whether the cell supports eCall over IMS services as defined in TS 23.501
[32]. If absent, eCall over IMS is not supported by the network in the cell.
eDRX-AllowedIdle
The presence of this field indicates that extended DRX is allowed in the cell for UEs
in RRC_IDLE. The UE shall stop using extended DRX in RRC_IDLE if eDRX-
AllowedIdle is not present.
eDRX-AllowedInactive
The presence of this field indicates that extended DRX is allowed in the cell for UEs
in RRC_INACTIVE. The UE shall stop using extended DRX in RRC_INACTIVE if
eDRX-AllowedInactive is not present.
featurePriorities
Indicates priorities for features, such as RedCap, Slicing, SDT and MSG3-Repetitions
for Coverage Enhancements. These priorities are used to determine which
FeatureCombinationPreambles the UE shall use when a feature maps to more than
one FeatureCombinationPreambles, as specified in TS 38.321 [3]. A lower value
means a higher priority. The network does not signal the same priority for more than
one feature. The network signals a priority for all feature that map to at least one
FeatureCombinationPreambles.
halfDuplexRedCap-Allowed
The presence of this field indicates whether the cell supports half-duplex FDD
RedCap UEs.
hsdn-Cell
This field indicates this is a HSDN cell as specified in TS 38.304 [20].
hyperSFN
Indicates hyper SFN which increments by one when the SFN wraps around.
idleModeMeasurementsEUTRA
This field indicates that a UE that is configured for EUTRA idle/inactive
measurements shall perform the measurements while camping in this cell and report
availability of these measurements when establishing or resuming a connection in this
cell. If absent, a UE is not required to perform EUTRA idle/inactive measurements.
idleModeMeasurementsNR
This field indicates that a UE that is configured for NR idle/inactive measurements
shall perform the measurements while camping in this cell and report availability of
these measurements when establishing or resuming a connection in this cell. If absent,
a UE is not required to perform NR idle/inactive measurements.
ims-EmergencySupport
Indicates whether the cell supports IMS emergency bearer services for UEs in limited
service mode. If absent, IMS emergency call is not supported by the network in the
cell for UEs in limited service mode.
intraFreqReselectionRedCap
Controls cell selection/reselection to intra-frequency cells for RedCap UEs when this
cell is barred, or treated as barred by the RedCap UE, as specified in TS 38.304 [20].
If not present, a RedCap UE treats the cell as barred, i.e., the UE considers that the cell
does not support RedCap.
q-QualMin
Parameter “Q_{qualmin}” in TS 38.304 [20], applicable for serving cell. If the field is
absent, the UE applies the (default) value of negative infinity for Q_{qualmin}.
q-QualMinOffset
Parameter “Q_{qualminoffset}” in TS 38.304 [20]. Actual value Q_{qualminoffset} = field value
[dB]. If the field is absent, the UE applies the (default) value of 0 dB for Q_{qualminoffset}.
Affects the minimum required quality level in the cell.
q-RxLevMin
Parameter “Qᵣₓₗₑᵥₘᵢₙ” in TS 38.304 [20], applicable for serving cell.
q-RxLevMinOffset
Parameter “Q_{rxlevminoffset}” in TS 38.304 [20]. Actual value Q_{rxlevminoffset} = field value * 2
[dB]. If absent, the UE applies the (default) value of 0 dB for Q_{rxlevminoffset}. Affects the
minimum required Rx level in the cell.
q-RxLevMinSUL
Parameter “Qᵣₓₗₑᵥₘᵢₙ” in TS 38.304 [20], applicable for serving cell.
sdt-RSRP-Threshold
RSRP threshold used to determine whether SDT procedure can be initiated, as
specified in TS 38.321 [3].
sdt-DataVolumeThreshold
Data volume threshold used to determine whether SDT can be initiated, as specified
in TS 38.321 [3]. Value byte32 corresponds to 32 bytes, value byte100 corresponds to
100 bytes, and so on.
sdt-LogicalChannelSR-DelayTimer
The value of logicalChannelSR-DelayTimer applied during SDT for logical channels
configured with SDT, as specified in TS 38.321 [3]. Value in number of subframes.
Value sf20 corresponds to 20 subframes, sf40 corresponds to 40 subframes, and so on.
If this field is not configured, then logicalChannelSR-DelayTimer is not applied for
SDT logical channels.
servingCellConfigCommon
Configuration of the serving cell.
t319a
Initial value of the timer T319a. Value ms100 corresponds to 100 milliseconds, value
ms200 corresponds to 200 milliseconds and so on.
uac-AccessCategory1-SelectionAssistanceInfo
Information used to determine whether Access Category 1 applies to the UE, as
defined in TS 22.261 [25]. If plmnCommon is chosen, the UAC-AccessCategory1-
SelectionAssistanceInfo is applicable to all the PLMNs and SNPNs in plmn-
IdentityInfoList and npn-IdentityInfoList. If individualPLMNList is chosen, the 1^{st}
entry in the list corresponds to the first network within all of the PLMNs and SNPNs
across the plmn-IdentityList and the npn-IdentityInfoList, the 2^{nd} entry in the list
corresponds to the second network within all of the PLMNs and SNPNs across the
plmn-IdentityList and the npn-IdentityInfoList and so on. If uac-AC1-SelectAssistInfo-
r16 is present, the UE shall ignore the uac-AccessCategory1-SelectionAssistanceInfo.
uac-AC1-SelectAssistInfo
Information used to determine whether Access Category 1 applies to the UE, as
defined in TS 22.261 [25]. The 1^{st} entry in the list corresponds to the first network
within all of the PLMNs and SNPNs across the plmn-IdentityList and npn-
IdentityInfoList, the 2^{nd} entry in the list corresponds to the second network within all
of the PLMNs and SNPNs across the plmn-IdentityList and the npn-IdentityInfoList
and so on. Value notConfigured indicates that Access Category1 is not configured for
the corresponding PLMN/SNPN.
uac-BarringForCommon
Common access control parameters for each access category. Common values are
used for all PLMNs/SNPNs, unless overwritten by the PLMN/SNPN specific
configuration provided in uac-BarringPerPLMN-List. The parameters are specified
by providing an index to the set of configurations (uac-BarringInfoSetList). UE
behaviour upon absence of this field is specified in clause 5.3.14.2.
ue-TimersAndConstants
Timer and constant values to be used by the UE. The cell operating as PCell always
provides this field.
useFullResumeID
Indicates which resume identifier and Resume request message should be used. UE
uses fullI-RNTI and RRCResumeRequest1 if the field is present, or shortI-RNTI and
RRCResumeRequest if the field is absent.

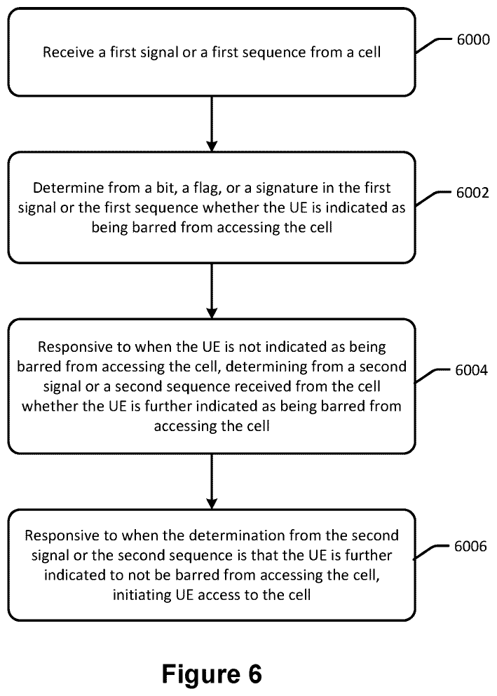

FIG. 6 is a flowchart of operations that can be implemented by a UE in accordance with some embodiments of the present disclosure. Referring to FIG. 6, the operations implemented by the UE include to receive 6000 a first signal or a first sequence from a cell. The operations further include to determine 6002 from a bit, a flag, or a signature in the first signal or the first sequence whether the UE is indicated as being barred from accessing the cell.

In a further embodiment, the operations implemented by the UE include, responsive to when a result of the determination 6002 is that the UE is not indicated as being barred from accessing the cell, determining 6004 from a second signal or a second sequence received from the cell whether the UE is further indicated as being barred from accessing the cell.

In a further embodiment, the operations implemented by the UE include, responsive to when the result of the determination 6002 from the second signal or the second sequence received from the cell is that the UE is further indicated to not be barred from accessing the cell, initiating 6006 UE access to the cell.

In some further embodiments, the first signal or the first sequence may be a Master Information Block (MIB) or a light weight MIB. The second signal or the second sequence may be a System Information Block (SIB). The SIB may be a SIB1 or a NES SIB.

In some further embodiments, the second signal or the second sequence includes information indicating whether the cell is barred or not barred for all NES capable UEs without indicating a particular NES technique to which the barred or not barred applies.

In some further embodiments, the second signal or the second sequence comprises information indicating whether the cell is barred or not barred for all NES capable UEs and further indicating a particular NES technique to which the barred or not barred applies.

In some further embodiments, the receiving 6000 of the first signal or the first sequence is performed on a network energy saving (NES) capable cell.

The NES capable cell may be configured with light weight Synchronization Signal Blocks (SSBs), discontinuous transmission (DTX), and/or network discontinuous reception (DRX).

In some further embodiments, the first UE is not capable of NES, which may be that the first UE is not capable of DTX and/or DRX.

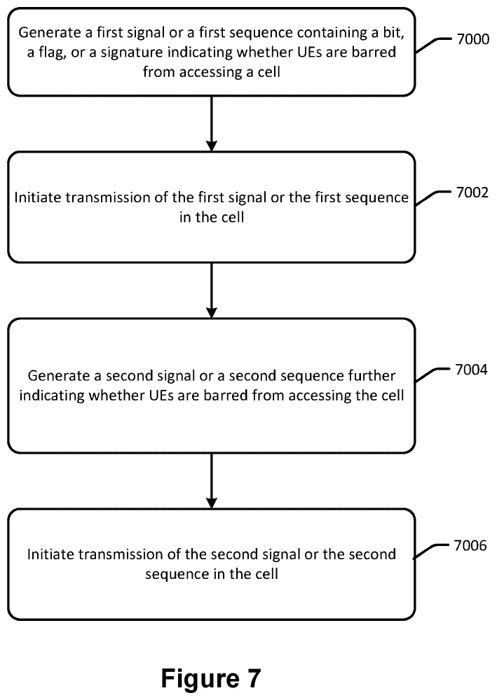

FIG. 7 is a flowchart of operations that can be implemented by a network node in accordance with some embodiments of the present disclosure. Referring to FIG. 7, the operations implemented by the network node include generating 7000 a first signal or a first sequence containing a bit, a flag, or a signature indicating whether UEs are barred from accessing a cell. The operations further include to initiating transmission 7002 the first signal or the first sequence in the cell.

In a further embodiment, when the indication of the first signal or the first sequence is that UEs are barred from accessing the cell, the operations implemented by the network node further include to generate 7004 a second signal or a second sequence further indicating whether UEs are barred from accessing the cell, and initiating transmission 7006 of the second signal or the second sequence in the cell.

In some further embodiments, the first signal or the first sequence may be a Master Information Block or a light weight MIB. The second signal or the second sequence may be a System Information Block (SIB), where the SIB may be SIB1 or a NES SIB.

The second signal or the second sequence may include information indicating whether the cell is barred or not barred for all NES capable UEs without indicating a particular NES technique to which the barred or not barred of UEs applies.

Alternatively, the second signal or the second sequence may include information indicating whether the cell is barred or not barred for all NES capable UEs and further indicating a particular NES technique to which the barred or not barred of UEs applies.

In a further embodiment, the operation by the network node for initiating transmission 7002 of the first signal or the first sequence in the cell is performed on a NES capable cell. The NES capable cell may be configured with light weight Synchronization Signal Blocks (SSBs), discontinuous transmission (DTX), and/or network discontinuous reception (DRX).

A listing of example Embodiments according to some other embodiments of the present disclosure is provided below:

1. A method implemented in a user equipment, UE, comprising:
receiving (6000) a first signal or a first sequence from a cell; and
determining (6002) from a bit, a flag, or a signature in the first signal or the first sequence whether the UE is indicated as being barred from accessing the cell.
   2. The method of Embodiment 1, further comprising:
responsive to when a result of the determination (6002) is that the UE is not indicated as being barred from accessing the cell, determining (6004) from a second signal or a second sequence received from the cell whether the UE is further indicated as being barred from accessing the cell.
   3. The method of Embodiment 2, further comprising:
responsive to when the result of the determination (6002) from the second signal or the second sequence received from the cell is that the UE is further indicated to not be barred from accessing the cell, initiating (6006) UE access to the cell.
   4. The method of any of Embodiments 1 to 3, wherein:
the first signal or the first sequence comprises a Master Information Block (MIB) or a light weight MIB.
   5. The method of any of Embodiments 2 to 4, wherein:
the second signal or the second sequence comprises a System Information Block (SIB).
   6. The method of Embodiment 5, wherein:
the System Information Block (SIB) comprises SIB1 or a network energy saving (NES) SIB.
   7 The method of any of Embodiments 2 to 6, wherein:
the second signal or the second sequence comprises information indicating whether the cell is barred or not barred for all network energy saving (NES) capable UEs without indicating a particular NES technique to which the barred or not barred applies.
   8. The method of any of Embodiments 2 to 6, wherein:
the second signal or the second sequence comprises information indicating whether the cell is barred or not barred for all network energy saving (NES) capable UEs and further indicating a particular NES technique to which the barred or not barred applies.
   9. The method of any of Embodiments 1 to 8, wherein:
the receiving (6000) of the first signal or the first sequence is performed on a network energy saving (NES) capable cell.
   10. The method of Embodiment 9, wherein:
the NES capable cell is configured with light weight Synchronization Signal Blocks (SSBs), discontinuous transmission (DTX), and/or network discontinuous reception (DRX).
   11. The method of any of Embodiments 1 to 10, wherein:
the first UE is not capable of network energy saving (NES).
   12. The method of Embodiment 11, wherein:
the first UE is not capable of discontinuous transmission (DTX) and/or discontinuous reception (DRX).
   13. A method implemented in a network node comprising:
generating (7000) a first signal or a first sequence containing a bit, a flag, or a signature indicating whether UEs are barred from accessing a cell; and
initiating transmission (7002) the first signal or the first sequence in the cell.
   14. The method of Embodiment 13, further comprising, when the indication of the first signal or the first sequence is that UEs are barred from accessing the cell:
generating (7004) a second signal or a second sequence further indicating whether UEs are barred from accessing the cell; and
initiating transmission (7006) of the second signal or the second sequence in the cell.
   15. The method of any of Embodiments 13 to 14, wherein:
the first signal or the first sequence comprises a Master Information Block or a light weight MIB.
   16. The method of any of Embodiments 14 to 15, wherein:
the second signal or the second sequence comprises a System Information Block (SIB).
   17. The method of Embodiment 16, wherein:
the SIB comprises SIB1 or a network energy saving (NES) SIB.
   18. The method of any of Embodiments 14 to 17, wherein:
the second signal or the second sequence comprises information indicating whether the cell is barred or not barred for all network energy saving (NES) capable UEs without indicating a particular NES technique to which the barred or not barred of UEs applies.
   19. The method of any of Embodiments 14 to 17, wherein:
the second signal or the second sequence comprises information indicating whether the cell is barred or not barred for all network energy saving (NES) capable UEs and further indicating a particular NES technique to which the barred or not barred of UEs applies.
   20. The method of any of Embodiments 13 to 19, wherein:
initiating transmission (7002) the first signal or the first sequence in the cell is performed on a network energy saving (NES) capable cell.
   21. The method of Embodiment 20, wherein:
the NES capable cell is configured with light weight Synchronization Signal Blocks (SSBs), discontinuous transmission (DTX), and/or network discontinuous reception (DRX).
   22. A user equipment, UE, (QQ112A-QQ112D) configured to communicate with a base station (QQ110A, QQ110B, QQ108), the UE comprising a radio interface and processing circuitry (QQ202) configured to:
receive a first signal or a first sequence from a cell; and
determine from a bit, a flag, or a signature in the first signal or the first sequence whether the UE is indicated as being barred from accessing the cell.
   23. The UE of Embodiment 22, wherein the processing circuitry (QQ202) is further configured to perform the method of any of Embodiments 2 to 12.
   24. A method implemented by a host operating in a communication system that further includes a network node and a user equipment, UE, the method comprising:
providing user data for the UE; and
initiating a transmission carrying the user data to the UE via a cellular network comprising the network node, wherein the UE performs the following operations to receive the user data from the host:
receiving (6000) a first signal or a first sequence from a cell; and
determining (6002) from a bit, a flag, or a signature in the first signal or the first sequence whether the UE is indicated as being barred from accessing the cell.
   25. The method of Embodiment 24 further comprising:
performing the method of any of Embodiments 2 to 12.
   26. A host configured to operate in a communication system to provide over-the-top, OTT, service, the host comprising:
processing circuitry configured to provide user data; and
a network interface configured to initiate transmission of the user data to a cellular network for transmission to a user equipment, UE, wherein the UE comprises a communication interface and processing circuitry, the communication interface and processing circuitry of the UE being configured to perform the following operations to receive the user data from the host:
receive a first signal or a first sequence from a cell; and
determine from a bit, a flag, or a signature in the first signal or the first sequence whether the UE is indicated as being barred from accessing the cell.
   27. The method of Embodiment 26, wherein the processing circuitry of the UE is further configured to perform the method of any of Embodiments 2 to 12.
   28. A network node (QQ110A, QQ110B, QQ108) configured to communicate with a plurality of user equipments, UEs, the network node comprising processing circuitry (QQ302) configured to:
generate a second signal or a second sequence further indicating whether UEs are barred from accessing the cell; and
initiate transmission of the second signal or the second sequence in the cell.
   29. The network node of Embodiment 28, wherein the processing circuitry of the source node is further configured to perform the method of any of Embodiments 14 to 21.
   30. A method implemented by a host configured to operate in a communication system that further includes a network node and a plurality of user equipments, UEs, the method comprising:
providing user data for the UEs; and
initiating transmissions carrying the user data to the UEs via a cellular network comprising the network node, wherein the network node performs the following operations to transmit the user data from the host to the UEs:
generating (7000) a first signal or a first sequence containing a bit, a flag, or a signature indicating whether UEs are barred from accessing a cell; and
   initiating transmission (7002) the first signal or the first sequence in the cell.
   31. The method of Embodiment 30 wherein the network node is further configured to: perform the method of any of Embodiments 14 to 21.
   32. A host configured to operate in a communication system to provide an over-the-top, OTT, service, the host comprising:
processing circuitry configured to provide user data; and
a network interface configured to initiate transmissions of the the user data to a network node in a cellular network for transmission to user equipments, UEs, the network node having a communication interface and processing circuitry, the processing circuitry of the network node configured to perform the following operations to transmit the user data from the host to the UEs:
generate a first signal or a first sequence containing a bit, a flag, or a signature indicating whether UEs are barred from accessing a cell; and
initiate transmission of the first signal or the first sequence in the cell.
   33. The host of Embodiment 32, wherein the processing circuitry of the source node is further configured to:
perform the method of any of Embodiments 14 to 21.
   34. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of Embodiments 13 to 21 to transmit the user data from the host to the UE.
   35. The communication system of Embodiment 34, further comprising:
the network node; and/or
the user equipment.

Various terms used herein are listed below with their abbreviations:

### Abbreviation Explanation

BW Bandwidth
CN Core Network
CU Centralizing Unit
DU Distributing Unit
FR2 Frequency Range 2
gNB gNodeB
HO Handover
HW Hardware
PF Paging Frame
NR New Radio
NW Network
OOS Out-of-Synchronization
RAN Radio Access Network
RLF Radio Link Failure
SIB1 System Information Block 1
SSB Synchronization Signal Block
UE User Equipment
UL Uplink

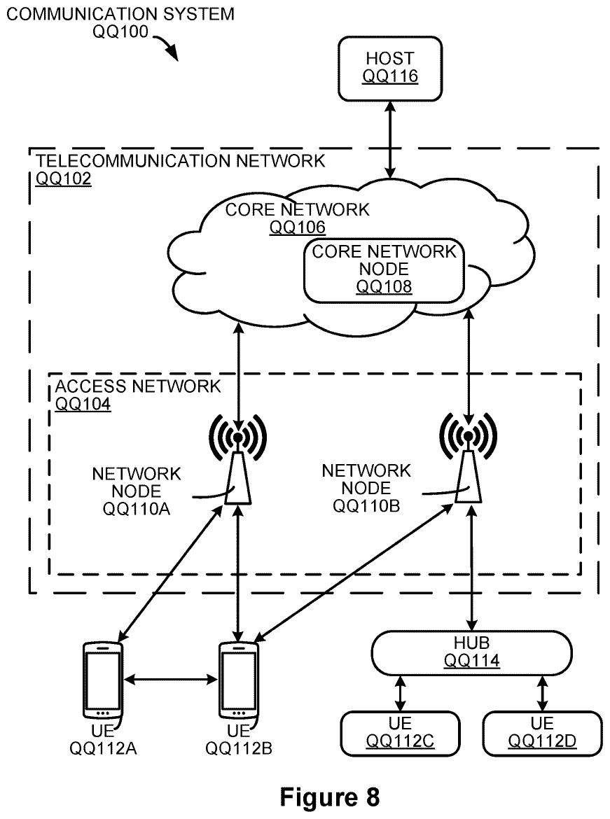

FIG. 8 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

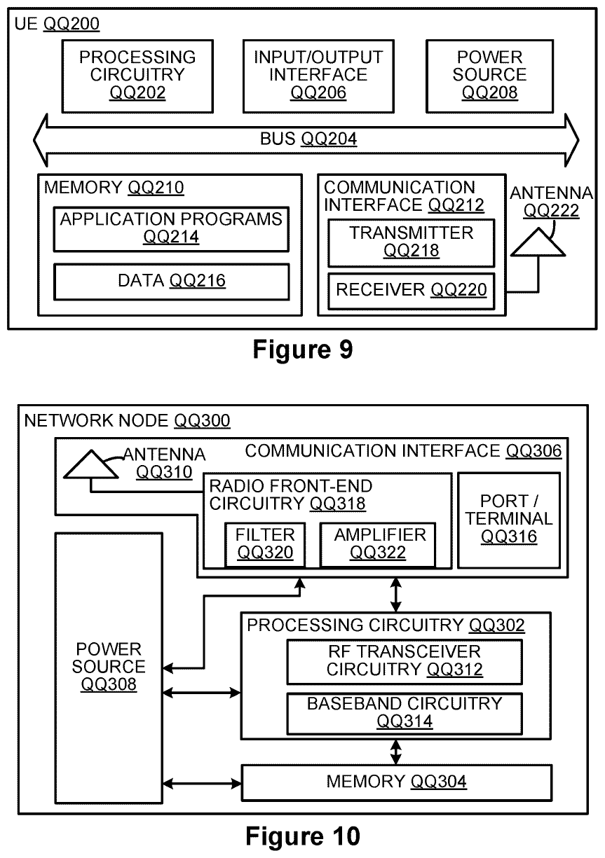

FIG. 9 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 10 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

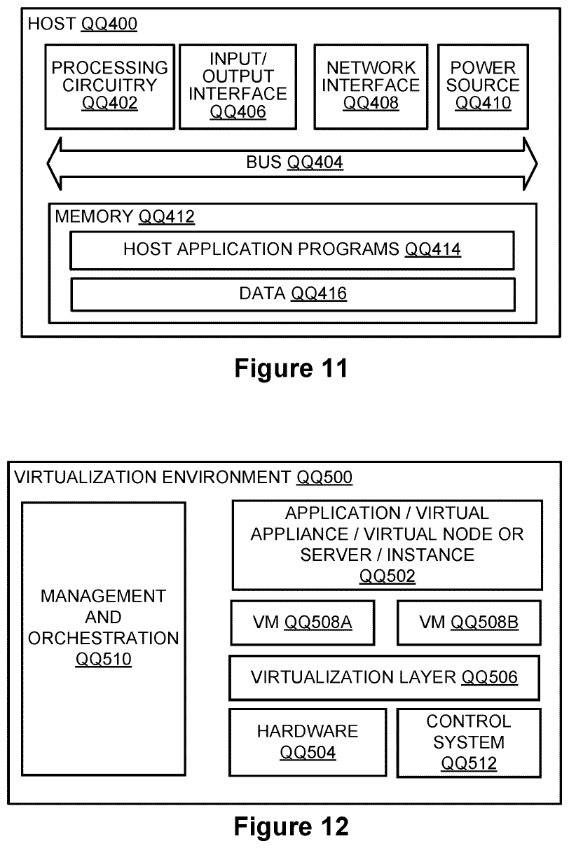

FIG. 11 is a block diagram of a host QQ400, which may be an embodiment of the host QQ116 of FIG. 8, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 9 and 10, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

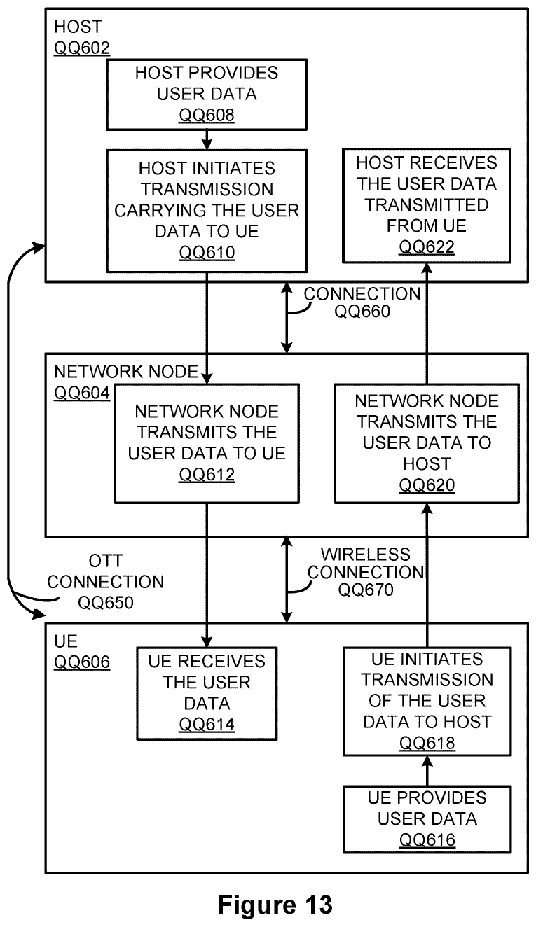

FIG. 13 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 8 and/or UE QQ200 of FIG. 9), network node (such as network node QQ110a of FIG. 8 and/or network node QQ300 of FIG. 10), and host (such as host QQ116 of FIG. 7 and/or host QQ400 of FIG. 11) discussed in the preceding paragraphs will now be described with reference to FIG. 13.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 8) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### APPENDIX

3GPP TSG-RAN WG2 #119-bis-e Tdoc DocNumber

Electronic meeting, Oct. 10-19, 2022

Agenda Item: 8.3.2

Source: Ericsson

Title: Handling of Legacy UEs on a NES Capable Cell

Document for: Discussion, Decision

### 1 Introduction

In RAN WG2 Meeting #119-e Error! Reference source not found. [0301], cell prioritization for legacy UEs was discussed and listed as one the network energy savings (NES) technique candidates for further study:

### Solution Groups:

1 Adaption of MIB/SSB/SIB
   partial/simplified SSB
2 Increase of SSB/SIB periodicity
3 On demand SSB/SIB1 (FFS if there are enhancements for other SIBs)
   FFS for on-demand MIB
4 Receiving SSB/SIB on one carrier/cell and performing access to another carrier/cell
5 Handover/Fast PCell change for NES
   CHO or new configuration
   group HO
6 Resource adaptation (frequency and time domain)
   Including PRACH, SRS, PUSCH, PUCCH resources and periodicities
   cell DTX/DRX
   measurement
   reference signal type and configuration of reference signal pattern for connected mode
   BWP adaptation
7 Any Cell activation/re-activation or UE wake up request signal (connected/idle)
8 Paging enhancements (includes paging-less solutions)
9 Cell selection/reselection (ie. cell prioritization also including legacy UEs)

### Things to Study

1 Study group configuration and signalling for transitions for different solutions
   pre-configuration and L1/L2 signaling to trigger change of configuration
2 Identify/capture RAN2 impact to legacy for the different solutions
3 Awareness of the NES states at the UE side for the different solutions
4 Aim to minimize DL signalling for NES
5 Consider UE complexity and energy consumption
6 UE assistance information for the specific network energy technique, it's benefits and impact to UE/NW

Furthermore, the concept was extended in the email discussion that was concluded with the following solution statement:

Solution 9: Cell selection/reselection (i.e., cell prioritization also including legacy UEs)

### Solution Statement:

| Introduction | NES cells can be (de-)prioritized for NES capable | |
|---|---|---|
| | UEs or legacy UEs during cell selection/reselection, optionally, | |
| | UE is made aware of cell state (NES or non-NES). | |
| Scenario | Single-carrier, multi-carrier; UEs in Idle/Inactive | |
| NES gain | Reduced time domain SSB symbols if the cell is in | |
| | NES state. Legacy UEs can avoid reselecting to an NES cell. | |
| Impact to | 1) | In case legacy mechanism (frequency priority, or adding |
| legacy UEs | | frequency/cell-specific offsets) is used, there is no impact on |
| | | legacy UEs |
| | 2) | In case cell state (NES, or non-NES, or other states) is |
| | | introduced, legacy UEs are not aware. The NES cells can be |
| | | barred to legacy UEs for backward compatibility. |
| UE | No | |
| assistance needed | | |

| | |
|---|---|
| RAN2 impact | Cell selection/reselection enhancement etc. |

This contribution discusses how to handle legacy UEs that are incapable of NES features configurable at the level of a serving cell and whether any further enhancement is needed for Solution 9 described above.

### 2. Discussion

An important aspect that needs to be taken into consideration when designing the NES techniques is a possible impact on the legacy UEs. In the case of a NES technique that is configurable at the level of a serving cell and that affect the legacy UEs (e.g., NW DTX/DRX configurable per serving cell), one solution would be to enhance cell barring through MIB with a cell barring through SIB as it was done for non-terrestrial networks (NTN) and Integrated Access and Backhaul Mobile Termination (IAB-MT) [0302].

Observation 1 Cell barring through SIB can be used to account for new features not supported by legacy, e.g., as in NTN, IAB-MT.

At the high level, for the cells that support NES features, the enhancement of cell barring through MIB with a cell barring through SIB would work as follows. When a cell is using a NES feature that is not supported by legacy UEs it can set itself as barred in MIB. The legacy UEs incapable of the NES feature will read the MIB and understand that the cell is barred. The NES capable UEs will ignore the information regarding cell barring in MIB and read the SIB, from which they can understand whether the cell is barred or not. Observe that the cell can be barred for the NES capable UEs as well in certain cases known to the NW, e.g., during the maintenance at the NW side. As described above, this can be done through SIB.

Proposal 1 For NES features configurable per serving cell that impact legacy UEs, enhance cell barring through MIB with a cell barring through SIB.

Apart from handing the impact on legacy UEs, the following enhancements are described for NES cell selection/reselection in Solution 9 captured during the email discussion:

NES cells can be (de-)prioritized for NES capable UEs or legacy UEs during cell selection/reselection, optionally, UE is made aware of cell state (NES or non-NES).

For NES capable UEs, we understand the cell selection/reselection procedure should not be affected in terms of prioritization of cells. It is important to observe that even if a cell is capable of a certain NES feature, it may not be using it all the time. Hence, the UE may take into account a NES aspect that may not be currently active on a cell. Such issues may need further discussion but do not seem to be tightly related to any NES gain. Therefore, for the current cell selection/reselection solution, we suggest focussing on addressing the impact on legacy UEs rather than introducing optimizations for NES capable UEs.

Proposal 2 For the cell selection/reselection solution, RAN2 should focus on how to handle the impact on legacy UEs.

### 3 Conclusion

In the previous sections we made the following observations:

Observation 1 Cell barring through SIB can be used to account for new features not supported by legacy, e.g., as in NTN, IAB-MT.

Based on the discussion in the previous sections we propose the following:
Proposal 1 For NES features configurable per serving cell that impact legacy UEs, enhance cell barring through MIB with a cell barring through SIB.
Proposal 2 For the cell selection/reselection solution, RAN2 should focus on how to handle the impact on legacy UEs.

### REFERENCES

[1] R2-2208703, 3GPP TSG-RAN WG2 Meeting #119-e, Electronic Meeting, Aug. 15-26, 2022; Report for Rel-17 Small data and URLLC/IIoT; Network energy savings for NR.
[2] 3GPP TS 38.331, Radio Resource Control (RRC) protocol specification, Release 17, v17.1.0, June 2022; 3rd Generation Partnership Project; Technical Specification Group Radio Access Network; NR.

1.-43. (canceled)

44. A method implemented in a user equipment, UE, comprising:
receiving a first signal or a first sequence from a cell, wherein the first signal or the first sequence comprises a Master Information Block (MIB) or a light weight MIB;
determining from a bit, a flag, or a signature in the first signal or the first sequence whether the UE is indicated as being barred from accessing the cell; and
responsive to when a result of the determination is that the UE is indicated as being barred from accessing the cell, determining from a second signal or a second sequence received from the cell whether the UE is further indicated as being barred from accessing the cell,
wherein the second signal or the second sequence comprises information indicating whether the cell is barred or not barred for all network energy saving (NES) capable UEs,
wherein the second signal or the second sequence comprises a System Information Block (SIB),
wherein the SIB comprises SIB1 or a network energy saving (NES) SIB.

45. The method of claim 44, further comprising:
responsive to when the result of the determination from the second signal or the second sequence received from the cell is that the UE is further indicated to be barred from accessing the cell, initiating UE access to the cell.

46. The method of claim 44, wherein:
the information indicates whether the cell is barred or not barred for all network energy saving (NES) capable UEs and without indicating a particular NES technique to which the barred or not barred applies.

47. The method of claim 44, wherein:
the information indicates whether the cell is barred or not barred for all network energy saving (NES) capable UEs and further indicates a particular NES technique to which the barred or not barred applies.

48. The method of claim 44, wherein:
the receiving of the first signal or the first sequence is performed on a network energy saving (NES) capable cell.

49. The method of claim 48, wherein:
the NES capable cell is configured with light weight Synchronization Signal Blocks (SSBs), discontinuous transmission (DTX), and/or network discontinuous reception (DRX).

50. The method of claim 44 wherein:
the first UE is not capable of network energy saving (NES).

51. The method of claim 50, wherein:
the first UE is not capable of discontinuous transmission (DTX) and/or discontinuous reception (DRX).

52. A method implemented in a network node comprising:
generating a first signal or a first sequence containing a bit, a flag, or a signature indicating whether UEs are barred from accessing a cell, wherein the first signal or the first sequence comprises a Master Information Block (MIB) or a light weight MIB;
initiating transmission of the first signal or the first sequence in the cell; and
responsive to when the indication of the first signal or the first sequence is that UEs are barred from accessing the cell,
generating a second signal or a second sequence further indicating whether UEs are barred from accessing the cell, wherein the second signal or the second sequence comprises information indicating whether the cell is barred or not barred for all network energy saving (NES) capable UEs, wherein the second signal or the second sequence comprises a System Information Block (SIB), wherein the SIB comprises SIB1 or a network energy saving (NES) SIB; and
initiating transmission of the second signal or the second sequence in the cell.

53. The method of any of claim 52, wherein:
the information indicates whether the cell is barred or not barred for all network energy saving (NES) capable UEs and without indicating a particular NES technique to which the barred or not barred of UEs applies.

54. The method of claim 52, wherein:
the information indicates whether the cell is barred or not barred for all network energy saving (NES) capable UEs and further indicates a particular NES technique to which the barred or not barred of UEs applies.

55. The method of claim 52, wherein:
initiating transmission the first signal or the first sequence in the cell is performed on a network energy saving (NES) capable cell.

56. The method of claim 55, wherein:
the NES capable cell is configured with light weight Synchronization Signal Blocks (SSBs), discontinuous transmission (DTX), and/or network discontinuous reception (DRX).

57. A user equipment, UE, configured to:
receive a first signal or a first sequence from a cell, wherein the first signal or the first sequence comprises a Master Information Block (MIB) or a light weight MIB;
determine from a bit, a flag, or a signature in the first signal or the first sequence whether the UE is indicated as being barred from accessing the cell; and
responsive to when a result of the determination is that the UE is indicated as being barred from accessing the cell, determine from a second signal or a second sequence received from the cell whether the UE is further indicated as being barred from accessing the cell,
wherein the second signal or the second sequence comprises information indicating whether the cell is barred or not barred for all network energy saving (NES) capable UEs,
wherein the second signal or the second sequence comprises a System Information Block (SIB),
wherein the SIB comprises SIB1 or a network energy saving (NES) SIB.

58. The UE of claim 57, being further configured to initiate UE access to the cell responsive to when the result of the determination from the second signal or the second sequence received from the cell is that the UE is further indicated to be barred from accessing the cell.

59. A network node configured to:
generate a first signal or a first sequence containing a bit, a flag, or a signature indicating whether UEs are barred from accessing a cell, wherein the first signal or the first sequence comprises a Master Information Block (MIB) or a light weight MIB;
initiate transmission of the first signal or the first sequence in the cell; and
responsive to when the indication of the first signal or the first sequence is that UEs are barred from accessing the cell, generate a second signal or a second sequence further indicating whether UEs are barred from accessing the cell, wherein the second signal or the second sequence comprises information indicating whether the cell is barred or not barred for all network energy saving (NES) capable UEs, wherein the second signal or the second sequence comprises a System Information Block (SIB), wherein the SIB comprises SIB1 or a network energy saving (NES) SIB; and
initiate transmission of the second signal or the second sequence in the cell.

60. The network node of claim 59, wherein the information indicates whether the cell is barred or not barred for all network energy saving (NES) capable UEs and without indicating a particular NES technique to which the barred or not barred of UEs applies.
